(19) United States
(12) Patent Application Publication
(10) Pub. No.: US 2016/0156915 A1
(43) Pub. Date: Jun. 2, 2016

(54) VIDEO ENCODING METHOD AND APPARATUS AND VIDEO DECODING METHOD AND APPARATUS USING VIDEO FORMAT PARAMETER DELIVERY

(71) Applicant: SAMSUNG ELECTRONICS CO., LTD., Gyeonggi-do (KR)

(72) Inventor: Byeong-doo CHOI, Suwon-si (KR)

(73) Assignee: SAMSUNG ELECTRONICS CO., LTD., Suwon-si (KR)

(21) Appl. No.: 14/906,033

(22) PCT Filed: Jul. 18, 2014
(86) PCT No.: PCT/KR2014/006556

§ 371 Date: Jan. 19, 2016

Related U.S. Application Data
(60) Provisional application No. 61/847,772, filed on Jul. 18, 2013.

(51) Int. Cl. H04N 19/33; H04N 19/60; H04N 19/70; H04N 19/136; H04N 19/44; H04N 19/187

(52) U.S. Cl. CPC H04N 19/33; H04N 19/44; H04N 19/187; H04N 19/70; H04N 19/136; H04N 19/60

(57) ABSTRACT

A video decoding method, which is performed by a multilayer video decoding apparatus, includes acquiring a bitstream of an encoded image, acquiring from the bitstream a video parameter set network abstraction layer (VPS NAL) unit including parameter information that is commonly used to decode base layer coded data and enhancement layer coded data, acquiring video format information that is commonly used to decode the base layer coded data and the enhancement layer coded data, by using the VPS NAL unit, and decoding the enhancement layer coded data using the video format information, in which the video format information includes at least one of spatial resolution information, luma and chroma specification information, color specification information, and viewpoint specification information.

### TECHNICAL FIELD

The present inventive concept relates to video encoding and decoding methods, and more particularly, to a method of delivering a video format parameter.

### BACKGROUND ART

As hardware for reproducing and storing high resolution or high quality video content is being developed and supplied, a need for a video codec for effectively encoding or decoding the high resolution or high quality video content is increasing. According to a video codec of a related art, a video is encoded according to a limited encoding method based on a coding unit having a tree structure.

Image data of the spatial domain is transformed into coefficients of the frequency domain via frequency transform. According to a video codec, an image is split into blocks having a certain size, discrete cosine transform (DCT) is performed on each block, and frequency coefficients are encoded in block units, for rapid calculation of frequency transform. Compression systems according to related arts perform block-based prediction so as to remove redundancy between color images. The compression systems according to related arts generate parameters used for video encoding and decoding in picture units.

### DETAILED DESCRIPTION OF THE INVENTIVE CONCEPT

### Technical Solution

According to an aspect of the present inventive concept, there is provided a video decoding method, which is performed by a multilayer video decoding apparatus, includes acquiring a bitstream of an encoded image, acquiring from the bitstream a video parameter set network abstraction layer (VPS NAL) unit including parameter information that is commonly used to decode base layer coded data and enhancement layer coded data, acquiring video format information that is commonly used to decode the base layer coded data and the enhancement layer coded data, by using the VPS NAL unit, and decoding the enhancement layer coded data using the video format information, in which the video format information includes at least one of spatial resolution information, luma and chroma specification information, color specification information, and viewpoint specification information.

The acquiring of the video format information may include acquiring from the VPS NAL unit an extension information identifier indicating whether extension information of the VPS NAL unit is supplied, and if a value of the extension information identifier is 1, acquiring the extension information of the VPS NAL unit from the bitstream, and the video format information from the extension information.

The acquiring of the video format information from the extension information may include acquiring from the extension information a video format information identifier indicating whether the video format information is supplied, and if a value of the video format information identifier is 1, acquiring the video format information from the bitstream.

The acquiring of the video format information may include acquiring information indicating whether a color component of a chroma format of at least one layer in the at least one layer indicated by the VPS NAL unit is encoded.

The acquiring of the video format information may include acquiring information indicating a coded picture width of a luma sample of at least one layer in the at least one layer indicated by the VPS NAL unit.

The acquiring of the video format information may include acquiring information indicating a bit depth of luma array samples of at least one layer in the at least one layer indicated by the VPS NAL unit.

The acquiring of the video format information may include acquiring a color specification identifier indicating whether chromaticity information, transfer characteristics information, and RGB-to-YCC transform matrix information are supplied to the VPS NAL unit, and if a value of the color specification identifier is 1, acquiring at least one of chromaticity information, transfer characteristics information, and RGB-to-YCC transform matrix information from the VPS NAL unit.

The acquiring of the video format information may include acquiring a neutral chroma identifier indicating whether all values of coded chroma samples generated through decoding are the same, and the decoding of the enhancement layer coded data comprises, if a value of the neutral chroma identifier is 1, generating values of chroma samples decoding by using the VPS NAL unit to be identical to each other.

The generating of the chroma samples may include determining values of the chroma samples with values of the chroma samples determined by using a bit depth of the chroma samples with respect to each layer acquired from the VPS NAL unit.

The acquiring of the video format information may include acquiring a viewpoint specification information indicating whether viewpoint specification information of a camera capturing an image is supplied to the VPS NAL unit, and if a value of the viewpoint specification information identifier is 1, acquiring a transform parameter to transform a depth value to a disparity value from the VPS NAL unit.

The VPS NAL unit may be located prior to a picture parameter set (PPS) NAL unit including parameter information that is commonly used to decode coded data of at least one picture of the image and a sequence parameter set (SPS) NAL unit including parameter information that is commonly used to decode coded data of pictures to be decoded by referring to a plurality of PPS NAL units, in a bitstream of the encoded image.

According to another aspect of the present inventive concept, there is provided a method of encoding an image, which is performed by a multilayer video encoding apparatus, which includes generating base layer coded data and enhancement layer coded data by encoding an input image, generating video format information that is commonly used to decode the base layer coded data and the enhancement layer coded data, generating a video parameter set network abstraction layer (VPS NAL) unit including parameter information that is commonly used to decode the base layer coded data and the enhancement layer coded data, and generating a bitstream including the VPS NAL unit, in which the video format information includes at least one of spatial resolution information, luma and chroma specification information, color specification information, and viewpoint specification information.

According to another aspect of the present inventive concept, there is provided a video decoding method in a multilayer video encoding apparatus, which includes a bitstream acquirer acquiring a bitstream of an encoded image, and an image decoder acquiring from the bitstream a video parameter set network abstraction layer (VPS NAL) unit including parameter information that is commonly used to decode base layer coded data and enhancement layer coded data, acquiring video format information that is commonly used to decode the base layer coded data and the enhancement layer coded data, by using the VPS NAL unit, and decoding the enhancement layer coded data using the video format information, in which the video format information includes at least one of spatial resolution information, luma and chroma specification information, color specification information, and viewpoint specification information.

According to another aspect of the present inventive concept, there is provided a video encoding apparatus in a multilayer video encoding apparatus, which includes an encoder generating base layer coded data and enhancement layer coded data by encoding an input image, generating video format information that is commonly used to decode the base layer coded data and the enhancement layer coded data, and generating a video parameter set network abstraction layer (VPS NAL) unit including parameter information that is commonly used to decode the base layer coded data and the enhancement layer coded data, and a bitstream generator generating a bitstream including the VPS NAL unit, in which the video format information includes at least one of spatial resolution information, luma and chroma specification information, color specification information, and viewpoint specification information.

According to another aspect of the present inventive concept, there is provided a non-transitory computer readable storage medium having stored thereon a program, which when executed by a computer, performs the method defined in any of the above methods.

### DESCRIPTION OF THE DRAWINGS

FIG. 1A is a block diagram of a video encoding apparatus, according to an embodiment.

FIG. 1B is a flowchart of a video encoding method, which is performed by a video encoding apparatus, according to an embodiment.

FIG. 2A is a block diagram of a video decoding apparatus, according to an embodiment.

FIG. 2B is a flowchart of a video decoding method, which is performed by a video decoding apparatus, according to an embodiment.

FIG. 3A is a diagram illustrating a structure of a header of a network abstraction layer (NAL) unit, according to an embodiment.

FIG. 3B is a diagram illustrating a syntax of a video parameter set (VPS), according to an embodiment.

FIG. 4 is a diagram illustrating a VPS extension syntax, according to an embodiment.

FIG. 5 is a diagram illustrating chromaticity coordinates used by an encoding apparatus, according to an embodiment.

FIG. 6 is a diagram illustrating photoelectric transfer characteristics transfer characteristics.

FIG. 7 is a diagram illustrating matrix coefficients used for the induction of luma and chroma signals from green, blue, and red primaries.

FIG. 8 is a block diagram of a video encoding apparatus based on coding units according to a tree structure, according to an embodiment.

FIG. 9 is a block diagram of a video decoding apparatus based on coding units according to a tree structure, according to an embodiment.

FIG. 10 is a diagram for describing a concept of coding units according to an embodiment.

FIG. 11 is a block diagram of a video encoder based on coding units, according to an embodiment.

FIG. 12 is a block diagram of a video decoder based on coding units, according to an embodiment.

FIG. 13 is a diagram illustrating coding units and partitions, according to an embodiment.

FIG. 14 is a diagram for describing a relationship between a coding unit and transform units, according to an embodiment.

FIG. 15 is a diagram for describing coding information of coding units, according to an embodiment.

FIG. 16 is a diagram of coding units, according to an embodiment.

FIGS. 17, 18, and 19 are diagrams for describing a relationship between coding units, prediction units, and transform units, according to an embodiment.

FIG. 20 is a diagram for describing a relationship between a coding unit, a prediction unit, and a transform unit, according to coding mode information of Table 2.

FIG. 21 is a diagram of a physical structure of a disc in which a program is stored, according to an embodiment.

FIG. 22 is a diagram of a disk drive for recording and reading a program by using a disc.

FIG. 23 is a diagram of an overall structure of a content supply system for providing a content distribution service.

FIGS. 24 and 25 are diagrams respectively of an external structure and an internal structure of a mobile phone to which a video encoding method and a video decoding method are applied, according to an embodiment.

FIG. 26 is a diagram of a digital broadcast system to which a communication system is applied, according to an embodiment.

FIG. 27 is a diagram illustrating a network structure of a cloud computing system using a video encoding apparatus and a video decoding apparatus, according to an embodiment.

### BEST MODE

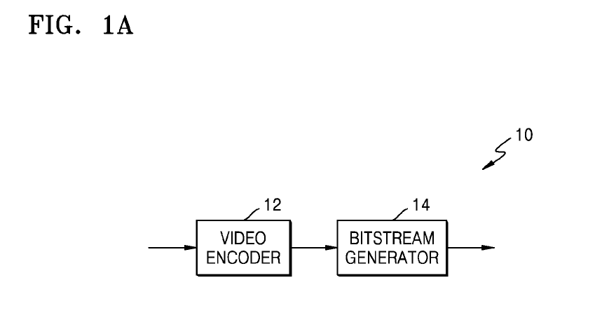

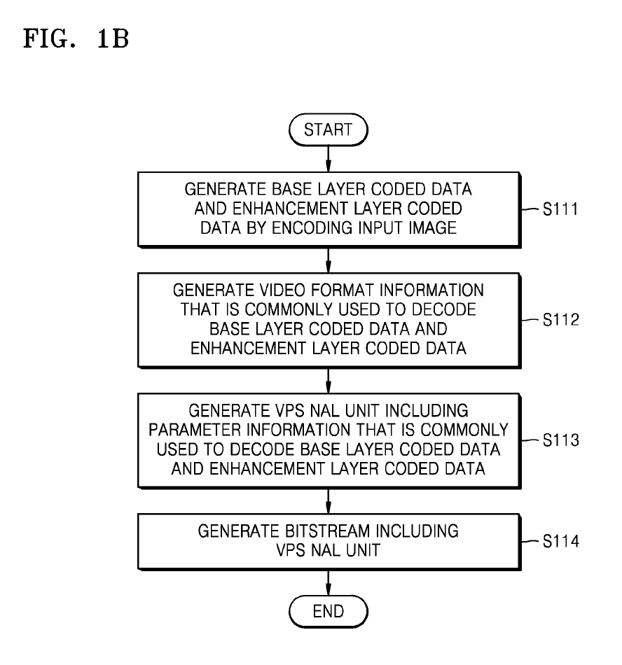

Hereinafter, referring to FIGS. 1A to 7, a video encoding method and a video decoding method for determining a prediction method of a disparity vector or a motion vector according to characteristics of a neighboring block of a current block according to various embodiments are proposed.

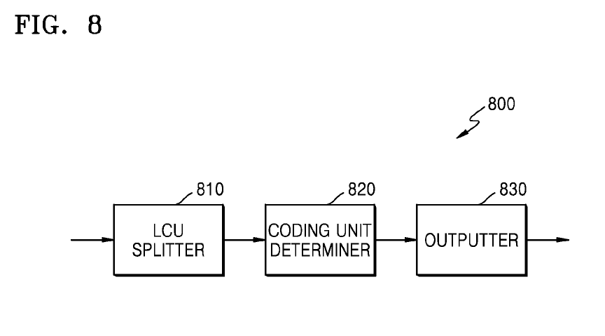

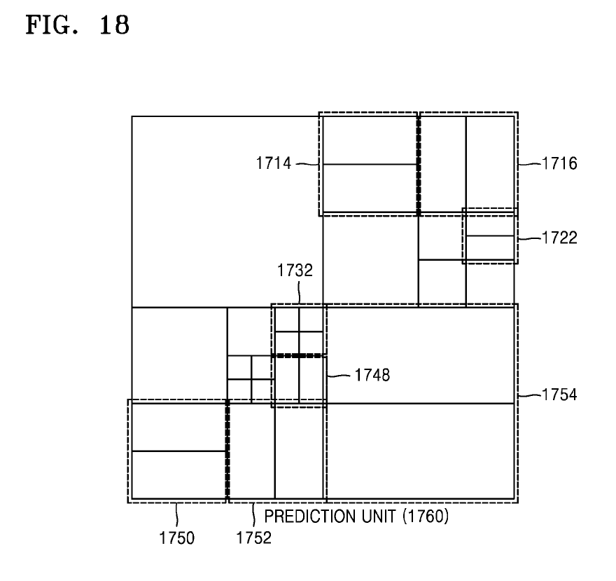

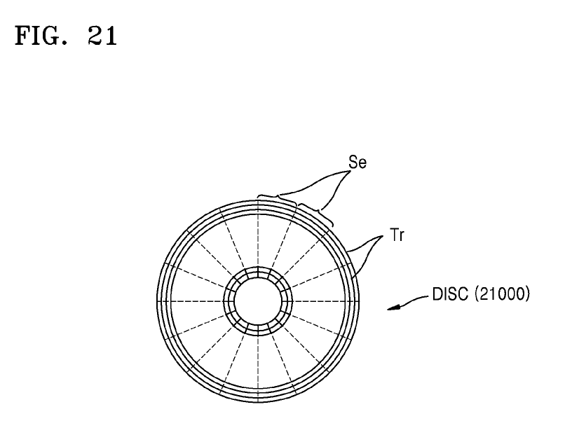

Furthermore, referring to FIGS. 8 to 20, a video encoding technique and a video decoding technique based on a coding unit having a tree structure according to various embodiments, which are applicable to the above-proposed video encoding method and decoding method, are disclosed. Furthermore, referring to FIGS. 21 to 27, various embodiments to which the above-proposed video encoding method and video decoding method are applicable are disclosed.

In the following description, an “image” may denote a still image of a video or a motion picture, that is, the video itself.

In the following description, a “sample” may denote data assigned to a sampling position of an image, which is subject to processing. For example, pixels of an image in a spatial area may be samples.

A current color block may denote a block of a color image to be coded or decoded.

A current color image may denote a color image in which a current color block is included. In detail, the current color image may denote a color image including a block to be coded or decoded.

A corresponding depth image corresponding to a current block may denote a depth image corresponding to a color image including the current block (current color image). For example, the corresponding depth image may denote an image indicating a depth value of a color image including a current block.

A neighboring block around the current block may denote at least one block coded or decoded and neighboring the current block. For example, the neighboring block around the current block may be located at an upper end, an upper right end, a left end, a lower left end, or an upper left end of the current block.

A collocated depth block in the corresponding depth map may denote a depth image block included in the corresponding depth image corresponding to the current block. For example, a corresponding block may include a block located at the same position as the current color block in the corresponding depth image corresponding to a color image.

A collocated depth macroblock may denote a depth image block of a higher concept including the corresponding block of a depth image.

A neighboring color image around the color image comprising the current color block may denote a color image having a viewpoint different from that of a color image including the current color block. The neighboring color image may be a color image coded or decoded before an image processing process is performed on the current color block.

First, referring to FIGS. 1A to 7, video encoding and encoding methods and video decoding and decoding methods according to various embodiments are described.

A method of encoding and decoding a multilayer image is disclosed. For example, multi-view video coding (MVC) and scalable video coding (SVC) provide a method of encoding and decoding an image using a plurality of layers.

The MVC is a method of compressing a multi-view video. A multi-view video is a stereoscopic three-dimensional image obtained by simultaneously capturing a scene from a variety of viewpoints using a plurality of cameras. In general, in the MVC, a basic viewpoint image is encoded as a base layer and an additional viewpoint image is enclosed as an enhancement layer.

The stereoscopic three-dimensional image signifies a three-dimensional image that simultaneously provides shape information about a depth and a space. Unlike a stereoscopy that simply provides images of different viewpoints to the left and right eyes, in order to provide an image like one viewed in a different direction whenever an observer changes a viewpoint, images captured at multiple viewpoints are needed. Since data of images captured at multiple viewpoints is huge, when the data is compressed using a coder optimized for single-view video coding such as MPEG-2 or H.264/AVC, an amount of data to be transmitted is so large that, considering a current network infrastructure and a current ground wave bandwidth, it is practically impossible to provide the image like one viewed in a different direction whenever an observer changes a viewpoint.

Accordingly, an amount of data generated during compression may be reduced by creating a depth image and compressing and transmitting the depth image with images of some viewpoints among images of multiple viewpoints, instead of compressing and transmitting the entire video at multiple viewpoints. Since the depth image is an image in which a distance between an object and a viewer is represented by a value of 0˜255 in a color image, the characteristics of depth image are similar to those of the color image. In general, a 3D video includes a color image and depth image at multiple viewpoints. However, since the 3D videos have temporal redundancy between temporally consecutive images as well as much temporal redundancy between different viewpoints, the three-dimensional image may be transmitted with a relatively small amount of data by performing compression using a coding system to efficiently remove redundancy between different viewpoints.

The SVC is an image compression method that provides various scalable services in terms of time, space, and image quality according to various user environments such as a network situation or a resolution of a terminal in a variety of multimedia environments. In the SVC, base layer coded data generally includes data for encoding a low-resolution image, whereas enhancement layer coded data generally includes coded data for encoding a high-resolution image by being coded together with the base layer coded data.

According to encoding and decoding methods of the present embodiment, in performing multilayer encoding and decoding, a method of signaling video format information using a video parameter set (VPS) is provided. The video format information including at least one of spatial resolution (width/height), bit depth, chroma format, color specification, luma-to-depth ratio, and frame packing, and indication of interlacing may be signaled through the VPS. The video format information may be used for session negotiation and content selection. In addition, viewpoint information may be signaled. The bit depth may include a bit depth for luma and chroma.

FIG. 1A is a block diagram of a video encoding apparatus 10 according to an embodiment. The video encoding apparatus 10 according to the present embodiment may include a video encoder 12 and a bitstream generator 14. The video encoder 12 generates base layer coded data by encoding an input image. The video encoder 12 generates enhancement layer coded data by encoding the input image. Although the base layer coded data and the enhancement layer coded data may be independently generated without referring to each other with respect to the input image, the video encoder 12 may generate the enhancement layer coded data using the base layer coded data. For example, the video encoder 120 may generate enhancement layer coded data by encoding the input image based on the base layer coded data.

The video encoder 12 generates video format information that is commonly used to decode the base layer coded data and the enhancement layer coded data. The video encoder 12 may generate a video parameter set network abstraction layer (VPS NAL) unit including parameter information that is commonly used to decode the base layer coded data and the enhancement layer coded data. The video format information may include at least one of spatial resolution information, luma and chroma specification information, color specification information, and viewpoint specification information.

For example, the video encoder 12 may generate information indicating whether a color component of a chroma format of at least one layer in the at least one layer indicated by the VPS NAL unit is encoded. The video encoder 12 may generate a VPS NAL unit including information indicating a coded picture width of a luma sample of at least one layer. The video encoder 12 may generate information indicating a bit depth of luma array samples and a VPS NAL unit including the bit depth.

The video encoder 12 may generate at least at least one of chromaticity information, transfer characteristics information, and RGB-to-YCC transform matrix information, and generate a VPS NAL unit including the information. The video encoder 12 may generate a color specification identifier indicating whether chromaticity information, transfer characteristics information, and RGB-to-YCC transform matrix information is supplied, and generate a VPS NAL unit including the color specification identifier.

When values of chroma samples coded by using the VPS NAL unit are the same, the video encoder 12 may generate a neutral chroma identifier indicating whether all values of coded chroma samples are the same, and generate a VPS NAL unit including the neutral chroma identifier. In another embodiment, the value of the identifier may be reversely applied so that the value of the identifier may be set to 0 to indicate that the values of the chroma samples are identically generated.

The video encoder 12 may generate a transform parameter to transform a depth value to a disparity value, and generate a VPS NAL unit including the transform parameter. In another embodiment, the value of the identifier may be set to 0 to indicate that the parameter may be generated by reversely applying the value of the identifier. The video encoder 12 may generate a viewpoint specification information identifier indicating whether viewpoint specification information of a camera that generated an image is supplied to the VPS, and generate a VPS NAL unit including the viewpoint specification information identifier.

The video encoder 12 may generate video format information that is commonly used to encode the base layer coded data and the enhancement layer coded data, and generate a VPS NAL unit including the video format information. In another embodiment, the video format information may be included not in the VPS NAL unit, but in a sequence parameter set (SPS) NAL unit or a picture parameter set (PPS) NAL unit. The video encoder 12 may generate a bitstream such that the VPS NAL unit is located prior to the SPS and PPS NAL units in the bitstream.

The PPS is a parameter set for at least one picture. For example, the PPS is a parameter set including parameter information that is commonly used to encode image coded data of the at least one picture. The PPS NAL unit is a NAL unit including the PPS. The SPS is a parameter set for a sequence. The sequence is a set of the at least one picture. For example, the SPS may include parameter information that is commonly used to encode coded data of pictures to be encoded by referring to at least one PPS.

The video format information may be included as VPS extension information. For example, the video format information may be included in the VPS NAL unit as the VPS extension information according to a VPS extended structure. In this case, the VPS NAL unit may include an extension information identifier indicating whether extension information of the VPS NAL unit is supplied.

The video encoder 12 may generate the extension information identifier indicating whether the extension information of the VPS NAL unit is supplied, and generate a VPS NAL unit including the extension information identifier. For example, the video encoder 12 may generate video format information to be included in the VPS extension information, and generate the VPS NAL unit including the VPS extension information. In this state, a value of the extension information identifier of the VPS may be set to 1. When the VPS extension information of the VPS NAL unit is not generated, the video encoder 12 may set the value of the extension information identifier to 0. In another embodiment, the video encoder 12 may set the values “1” and “0” of the extension information identifier to indicate the opposite states.

The VPS may include a video format information identifier indicating whether the video format information of a video format is supplied. The video encoder 12 may generate a video format information identifier indicating whether the video format information is supplied, and generate a VPS NAL unit including the video format information identifier. Meanwhile, the video format information identifier indicating whether the video format information is supplied may be included in the VPS extended structure.

After generating the video format information and setting the value of the video format information identifier to 1, the video encoder 12 may generate a VPS NAL unit including the video format information and the video format information identifier.

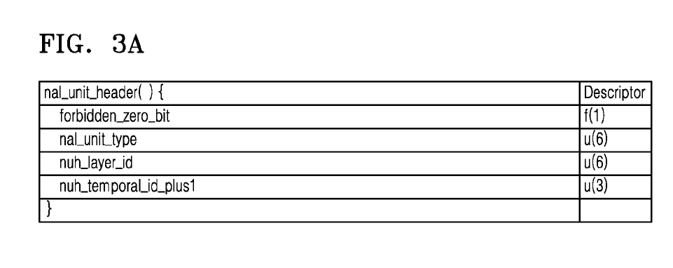

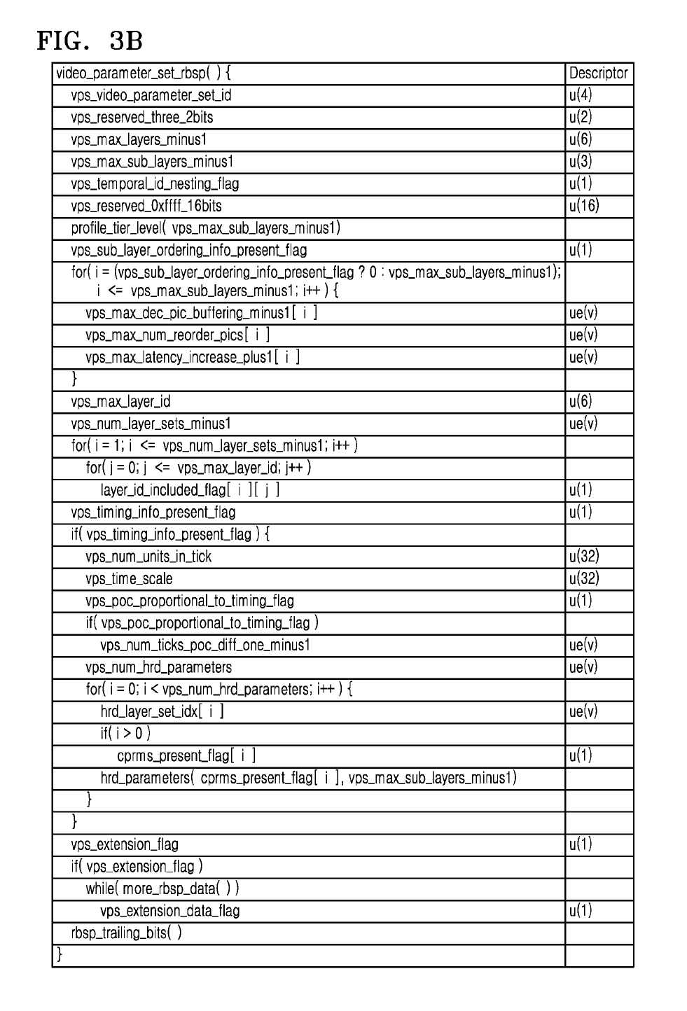

When the video format information is not generated, the video encoder 12 may set the value of the video format information identifier to 0. In another embodiment, the value of the identifier may be reversely applied so that the value of the identifier may be set to 0 to indicate that the information is generated. The video format parameter is described in detail below with reference to FIGS. 3A to 7.

The bitstream generator 14 generates a bitstream including the VPS NAL unit. For example, the bitstream generator 14 may generate a bitstream including the VPS NAL unit, the SPS NAL unit, and the PPS NAL unit.

FIG. 1B is a flowchart of a video encoding method, which is performed by the video encoding apparatus 10, according to an embodiment.

First, the video encoding apparatus 10 generates base layer coded data and enhancement layer coded data by encoding an input image (S111). For example, the video encoding apparatus 10 generates base layer coded data by encoding an input image. The video encoding apparatus 10 generates enhancement layer coded data by encoding the input image. Although the base layer coded data and the enhancement layer coded data may be independently generated without referring to each other with respect to the input image, the video encoding apparatus 10 may generate the enhancement layer coded data by using the base layer coded data. For example, the video encoding apparatus 10 may generate the enhancement layer coded data by encoding the input image based on the base layer coded data.

Next, the video encoding apparatus 10 generates video format information that is commonly used to decode the base layer coded data and the enhancement layer coded data (S112).

Next, the video encoding apparatus 10 generates a VPS NAL unit including parameter information that is commonly used to decode the base layer coded data and the enhancement layer coded data (S113). The video format information may include at least one of spatial resolution information, luma and chroma specification information, color specification information, and viewpoint specification information.

For example, the video encoding apparatus 10 may generate information indicating whether a color component of a chroma format of at least one layer in the at least one layer indicated by the VPS NAL unit is encoded. The video encoding apparatus 10 may generate a VPS NAL unit including information indicating a coded picture width of a luma sample of the at least one layer. The video encoding apparatus 10 may generate information indicating a bit depth of luma array samples, and generate a VPS NAL unit including the information.

The video encoding apparatus 10 may generate at least one of chromaticity information, transfer characteristics information, and RGB-to-YCC transform matrix information, and generate a VPS NAL unit including the at least one piece of information. The video encoding apparatus 10 may generate a color specification identifier indicating whether chromaticity information, transfer characteristics information, and RGB-to-YCC transform matrix information are supplied, and generate a VPS NAL unit including the color specification identifier.

When values of chroma samples coded by using the VPS NAL unit are the same, the video encoding apparatus 10 may generate a neutral chroma identifier indicating whether all values of coded chroma samples are the same, and generate a VPS NAL unit including the neutral chroma identifier. In another embodiment, the values of the identifier may be reversely applied so that the value of the identifier may be set to 0 to indicate that the values of the chroma samples are identically generated.

The video encoding apparatus 10 may generate a transform parameter to transform a depth value to a disparity value, and generate a VPS NAL unit including the transform parameter. In another embodiment, the value of the identifier may be reversely applied so that the value of the identifier may be set to 0 to indicate that the parameter is generated. The video encoding apparatus 10 may generate a viewpoint specification information identifier indicating whether viewpoint specification information of a camera that captured an image to the VPS, and generate a VPS NAL unit including the viewpoint specification information identifier.

The video encoding apparatus 10 may generate video format information that is commonly used to encode the base layer coded data and the enhancement layer coded data, and generate a VPS NAL unit including the video format information. In another embodiment, the video format information may be included not in the VPS NAL unit, but in the SPS NAL unit or the PPS NAL unit. The video encoding apparatus 10 may generate a bitstream in which the VPS NAL unit is located prior to the SPS and PPS NAL units in the bitstream.

The PPS is a parameter set for at least one picture. For example, the PPS is a parameter set including parameter information that is commonly used to encode image coded data of at least one picture. The PPS NAL unit is an NAL unit including information about the PPS. The SPS is a parameter set for a sequence. The sequence is a set of at least one picture. For example, the SPS may include parameter information that is commonly used to encode coded data of pictures to be encoded by referring to the PPS.

The video format information may be included as VPS extension information. For example, the video format information may be included in the VPS NAL unit as VPS extension information according to the VPS extended structure. In this case, the VPS NAL unit may include an extension information identifier indicating whether the extension information of the VPS NAL unit is supplied.

The video encoding apparatus 10 may generate an extension information identifier indicating whether the extension information of the VPS NAL unit is supplied, and generate a VPS NAL unit including the extension information identifier. For example, the video encoding apparatus 10 may generate video format information to be included in the VPS extension information, and generate a VPS NAL unit including the VPS extension information and set the value of the extension information identifier of the VPS to 1. When the extension information of the VPS NAL unit is not generated, the video encoding apparatus 10 may set the value of the extension information identifier to 0. In another embodiment, the video encoding apparatus 10 may set the values “1” and “0” of the extension information identifier to indicate the opposite states.

The VPS may include a video format information identifier indicating whether the video format information of a video format is supplied. The video encoding apparatus 10 may generate a video format information identifier indicating whether the video format information is supplied, and generate a VPS NAL unit including the video format information identifier. The video format information identifier indicating whether the video format information is supplied may be included in the VPS extended structure.

The video encoding apparatus 10 may generate video format information, set the value of the video format information identifier to 1, and then, generate a VPS NAL unit including the video format information and the video format information identifier.

When the video format information is not generated, the video encoding apparatus 10 may set the value of the video format information identifier to 0. In another embodiment, the value of the identifier may be reversely applied so that the value of the identifier may be set to 0 to indicate that the information is generated.

Next, the video encoding apparatus 10 generates a bitstream including the VPS NAL unit (S114). For example, the video encoding apparatus 10 may generate a bitstream including the VPS NAL unit, the SPS NAL unit, and the PPS NAL unit.

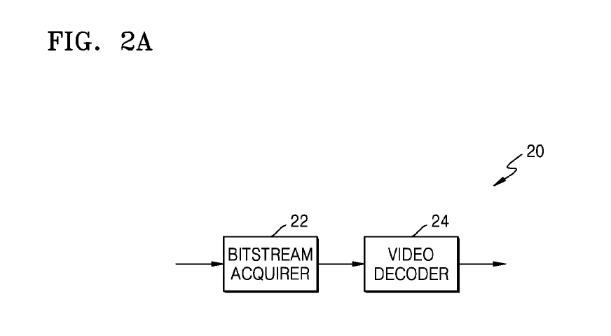

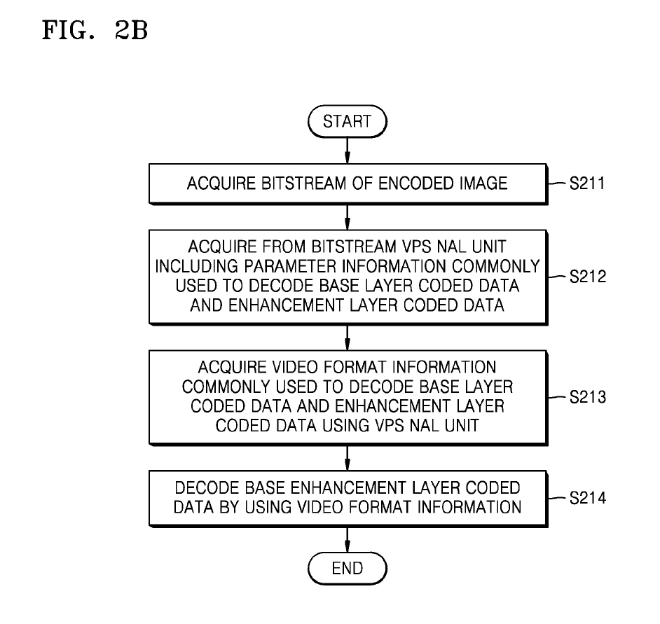

FIG. 2A is a block diagram of a video decoding apparatus 20, according to an embodiment. The video decoding apparatus 20 according to the present embodiment may include a bitstream acquirer 22 and a video decoder 24.

The bitstream acquirer 22 acquires a bitstream of an encoded image.

The video decoder 24 decodes the base layer coded data and enhancement layer coded data by using the video format information.

For example, in the case of the MVC, the video decoder 24 may acquire the base layer coded data and the base layer video format information from the bitstream. The video decoder 24 may decode the base layer coded data by using the acquired base layer coded data and base layer video format information. Furthermore, the video decoder 24 may acquire the enhancement layer coded data and the video format information from the bitstream. The video decoder 24 may decode the enhancement layer coded data by using the acquired enhancement layer coded data and enhancement layer video format information.

The video format information may be commonly used to decode the base layer coded data and the enhancement layer coded data. For example, the video decoder 24 may acquire the base layer coded data and the video format information from the bitstream. The video decoder 24 may decode the base layer coded data by using the acquired base layer coded data and the video format information. The video decoder 24 may acquire the enhancement layer coded data from the bitstream. The video decoder 24 may decode the enhancement layer coded data by using the acquired enhancement layer coded data and video format information.

As described above, the base layer coded data and the enhancement layer coded data may be independently decoded without referring to each other with respect to an input image. When at least any one of the base layer coded data and the enhancement layer coded data refers to the other one, the video decoder 24 may decode the image by using the reference relationship. For example, when the enhancement layer coded data refers to the base layer coded data, the video decoder 24 may decode the enhancement layer coded data by using the base layer coded data.

The video decoder 24 acquires a VPS NAL unit including parameter information that is commonly used to decode the base layer coded data and the enhancement layer coded data from the bitstream, to perform decoding.

The video decoder 24 may acquire, by using the VPS NAL unit, the video format information that is commonly used to decode the base layer coded data and the enhancement layer coded data. The video format information may include at least one of spatial resolution information, luma and chroma specification information, color specification information, and viewpoint specification information. For example, the video decoder 24 may acquire information indicating whether a color component of a chroma format of at least one layer in the at least one layer indicated by the VPS NAL unit is encoded. The video decoder 24 may acquire information indicating a coded picture width of a luma sample of at least one layer in the at least one layer indicated by the VPS NAL unit. The video decoder 24 may acquire information indicating a bit depth of luma array samples of at least one layer in the at least one layer indicated by the VPS NAL unit.

The video decoder 24 may acquire a color specification identifier indicating whether chromaticity information, transfer characteristics information, and RGB-to-YCC transform matrix information are supplied to the VPS NAL unit. When the value of the color specification identifier is 1, the video decoder 24 may acquire at least one of chromaticity information, transfer characteristics information, and RGB-to-YCC transform matrix information from the VPS NAL unit. In another embodiment, the value of the identifier may be reversely applied so that the value of the identifier may be set to 0 to indicate that the information is acquired.

The video decoder 24 may acquire, from the bitstream, a neutral chroma identifier indicating whether all values of coded chroma samples generated through decoding are the same. Thus, when the value of the neutral chroma identifier is 1, the video decoder 24 may generate the values of the chroma samples decoded by using the VPS NAL unit to be identical to each other. For example, the video decoder 24 may determine the values of the chroma samples with the values of the chroma samples determined by using the bit depth of the chroma samples with respect to each layer acquired from the VPS NAL unit. In another embodiment, the values of the identifier may be reversely applied so that the value of the identifier may be set to 0 to indicate that the values of the chroma samples are generated to be the same.

The video decoder 24 may acquire, from the VPS NAL unit, a viewpoint specification information identifier indicating whether viewpoint specification information of a camera that captured an image is supplied to the VPS NAL unit. When the value of the viewpoint specification information identifier is 1, the video decoder 24 may acquire, from the VPS NAL unit, a transform parameter to transform a depth value to a disparity value. In another embodiment, the value of the identifier may be reversely applied so that the value of the identifier may be set to 0 to indicate that the parameter is acquired.

The video decoder 24 may acquire, from the bitstream, the video format information that is commonly used to decode the base layer coded data and the enhancement layer coded data. In another embodiment, the video format information may be included not in the VPS NAL unit, but in the SPS NAL unit or the PPS NAL unit. The VPS NAL unit may appear in the bitstream prior to the SPS and the PPS NAL unit.

The PPS is a parameter set for at least one picture. For example, the PPS is a parameter set including parameter information that is commonly used to decode image coded data of at least one picture. The PPS NAL unit is an NAL unit including information about the PPS. The SPS is a parameter set for a sequence. The sequence is a set of at least one picture. For example, the SPS may include the parameter information that is commonly used to decode coded data of pictures to be decoded by referring to the PPS.

The video format information may be included in the VPS extension information. For example, the video format information may be included in the VPS NAL unit according to the VPS extended structure. In this case, The VPS NAL unit may include an extension information identifier indicating whether the extension information of the VPS NAL unit is supplied.

The video decoder 24 may acquire, from the VPS NAL unit, an extension information identifier indicating whether the extension information of the VPS NAL unit is supplied. When the value of the extension information identifier is 1, the video decoder 24 may acquire, from the bitstream, the extension information of the VPS NAL unit, and acquire the video format information from the extension information. When the value of the extension information identifier is 0, the video decoder 24 may determine that the extension information of the VPS NAL unit is not included in the bitstream. Accordingly, the video decoder 24 may determine that information according to the VPS extension information is not included in the bitstream.

In another embodiment, when the value of the extension information identifier is 0, the video decoder 24 may acquire the extension information of the VPS NAL unit from the bitstream and the video format information from the extension information. When the value of the extension information identifier is 1, the video decoder 24 may determine that the extension information of the VPS NAL unit is not included in the bitstream.

The VPS may include a video format information identifier indicating whether the video format information about a video format is supplied. The video decoder 24 may acquire, from the VPS, a video format information identifier indicating whether the video format information is supplied. The video format information identifier indicating whether the video format information is supplied may be included in the VPS extended structure.

When the value of the video format information identifier is 1, the video decoder 24 may acquire the video format information from the bitstream. When the value of the video format information identifier is 0, the video decoder 24 may determine that the video format information is not included in the bitstream. In another embodiment, the value of the identifier may be reversely applied so that the value of the identifier may be set to 0 to indicate that the information is acquired.

FIG. 2B is a flowchart of a video decoding method, which is performed by the video decoding apparatus 20, according to an embodiment.

First, the video decoding apparatus 20 acquires a bitstream of an encoded image (S211).

Next, the video decoding apparatus 20 may acquire, from the bitstream, a VPS NAL unit including parameter information that is commonly used to decode the base layer coded data and the enhancement layer coded data (S212).

Next, the video decoding apparatus 20 may acquire video format information that is commonly used to decode the base layer coded data and the enhancement layer coded data, by using the VPS NAL unit (S213). The video format information may include at least one of spatial resolution information, luma and chroma specification information, color specification information, and viewpoint specification information.

For example, the video decoding apparatus 20 may acquire information indicating whether a color component of a chroma format of at least one layer in the at least one layer indicated by the VPS NAL unit is encoded.

The video decoding apparatus 20 may acquire information indicating a coded picture width of a luma sample of at least one layer in the at least one layer indicated by the VPS NAL unit.

The video decoding apparatus 20 may acquire information indicating a bit depth of luma array samples of at least one layer in the at least one layer indicated by the VPS NAL unit.

The video decoding apparatus 20 may acquire a color specification identifier indicating whether chromaticity information, transfer characteristics information, and RGB-to-YCC transform matrix are supplied to the VPS NAL unit. When the value of the color specification identifier is 1, the video decoding apparatus 20 may acquire, from the VPS NAL unit, at least one of chromaticity information, transfer characteristics information, and RGB-to-YCC transform matrix information. In another embodiment, the value of the identifier may be reversely applied so that the value of the identifier may be set to 0 to indicate that the information is acquired.

The video decoding apparatus 20 may acquire, from the bitstream, a neutral chroma identifier indicating whether all values of coded chroma samples generated through decoding are the same. Thus, when the value of the neutral chroma identifier is 1, the video decoding apparatus 20 may generate the values of the chroma samples decoded by using the VPS NAL unit to be identical to each other. For example, the video decoding apparatus 20 may determine the values of the chroma samples with the values of the chroma samples determined by using the bit depth of the chroma samples with respect to each layer acquired from the VPS NAL unit. In another embodiment, the values of the identifier may be reversely applied so that the value of the identifier may be set to 0 to indicate that the values of the chroma samples are generated to be the same.

The video decoding apparatus 20 may acquire a viewpoint specification information identifier indicating whether viewpoint specification information of a camera capturing an image is supplied to the VPS NAL unit. When the value of the viewpoint specification information identifier is 1, the video decoding apparatus 20 may acquire, from the VPS NAL unit, a transform parameter to transform a depth value to a disparity value. In another embodiment, the value of the identifier may be reversely applied so that the value of the identifier may be set to 0 to indicate that the parameter is acquired.

The video decoding apparatus 20 may acquire, from the bitstream, the video format information that is commonly used to decode the base layer coded data and the enhancement layer coded data. In another embodiment, the video format information may be included not in the VPS NAL unit, but in the SPS NAL unit or the PPS NAL unit. The VPS NAL unit may appear in the bitstream prior to the SPS and the PPS NAL unit.

The PPS is a parameter set for at least one picture. For example, the PPS is a parameter set including parameter information that is commonly used to decode image coded data of at least one picture. The PPS NAL unit is an NAL unit including information about the PPS. The SPS is a parameter set for a sequence. The sequence is a set of at least one picture. For example, the SPS may include the parameter information that is commonly used to decode coded data of pictures to be decoded by referring to the PPS.

The video format information may be included in the VPS extension information. For example, the video format information may be included in the VPS NAL unit according to the VPS extended structure. In this case, The VPS NAL unit may include an extension information identifier indicating whether the extension information of the VPS NAL unit is supplied.

The video decoding apparatus 20 may acquire, from the VPS NAL unit, an extension information identifier indicating whether the extension information of the VPS NAL unit is supplied. When the value of the extension information identifier is 1, the video decoding apparatus 20 may acquire, from the bitstream, the extension information of the VPS NAL unit, and acquire the video format information from the extension information. When the value of the extension information identifier is 0, the video decoding apparatus 20 may determine that the extension information of the VPS NAL unit is not included in the bitstream. Accordingly, the video decoding apparatus 20 may determine that information according to the VPS extension information is not included in the bitstream.

In another embodiment, when the value of the extension information identifier is 0, the video decoding apparatus 20 may acquire the extension information of the VPS NAL unit from the bitstream and the video format information from the extension information. When the value of the extension information identifier is 1, the video decoding apparatus 20 may determine that the extension information of the VPS NAL unit is not included in the bitstream.

The VPS may include a video format information identifier indicating whether the video format information about a video format is supplied. The video decoding apparatus 20 may acquire, from the VPS, a video format information identifier indicating whether the video format information is supplied. The video format information identifier indicating whether the video format information is supplied may be included in the VPS extended structure.

When the value of the video format information identifier is 1, the video decoding apparatus 20 may acquire the video format information from the bitstream. When the value of the video format information identifier is 0, the video decoding apparatus 20 may determine that the video format information is not included in the bitstream. In another embodiment, the value of the identifier may be reversely applied so that the value of the identifier may be set to 0 to indicate that the information is acquired.

Next, the video decoding apparatus 20 decodes an output image using the video format information (S214). The video decoding apparatus 20 may acquire base layer coded data from the bitstream. The video decoding apparatus 20 may decode the base layer coded data using the acquired base layer coded data and the video format information. The video decoding apparatus 20 may further acquire enhancement layer coded data from the bitstream. The video decoding apparatus 20 may decode an output image using the acquired the acquired base layer coded data, enhancement layer coded data, and video format information.

For example, when an image is compressed by a multi-view compression method (multi-view coding), the video decoding apparatus 20 may decode a base layer image using the base layer coded data and the video format information, and decode an enhancement layer image using the enhancement layer coded data and the video format information.

The video decoding apparatus 20 may decode an output image using information such as spatial resolution information, luma and chroma specification information, and viewpoint specification information, which are included in the video format information. For example, for a video compressed by an SVC compression method, the video decoding apparatus 20 may determine whether to decode an image using only the base layer coded data or whether to decode an image by decoding the base layer coded data and the enhancement layer coded data altogether, by using the spatial resolution information included in the video format information, and performance information of the video decoding apparatus 20.

Furthermore, the video decoding apparatus 20 may decode the enhancement layer image by converting a depth value of a block to be coded to a disparity value of the block to be coded by using camera parameter information included in the video format information.

The base layer coded data and the enhancement layer coded data may be independently decoded without referring to each other with respect to an input image. When at least any one of the base layer coded data and the enhancement layer coded data refers to the other, the video decoding apparatus 20 may decode an image by using the reference relationship. For example, when the enhancement layer coded data refers to the base layer coded data, the video decoding apparatus 20 may decode the enhancement layer coded data by using the base layer coded data.

The video decoding apparatus 20 may perform post-treatment on the decoded image by using the parameter value included in the video format information. For example, the video decoding apparatus 20 may perform a post-treatment of correcting a color value of an output image by using the color specification information included in the video format information.

A method of acquiring video format information, which is performed by the video decoding apparatus 20, according to an embodiment is described in detail with reference to FIGS. 3A to 7.

FIG. 3A is a diagram illustrating a structure of a header of a NAL unit, according to an embodiment. The NAL unit may include a header. As illustrated in FIG. 3A, the header of a NAL unit may include nal_unit_type information. The nal_unit_type denotes the type of a NAL unit. For example, the nal_unit_type may indicate whether the NAL unit is one related to a parameter set or the NAL unit is one including coded data. For example, the nal_unit_type may indicate whether the NAL unit is a VPS NAL unit, an SPS NAL unit, or a PPS NAL unit. The VPS NAL unit may include a header as illustrated in FIG. 3A. Accordingly, the video decoding apparatus 20 may identify that the NAL unit is a VPS NAL unit by using the nal_unit_type information of the header information of the NAL unit read from the bitstream.

FIG. 3B is a diagram illustrating a syntax of a VPS, according to an embodiment. The video decoding apparatus 20 may acquire from a bitstream a VPS raw byte sequence code (RBSP). The video decoding apparatus 20 may acquire parameters included in the VPS according to the syntax of FIG. 3B. For example, the video decoding apparatus 20 may generate a VPS identifier value by acquiring a vps_video_parameter_set_id from the bitstream.

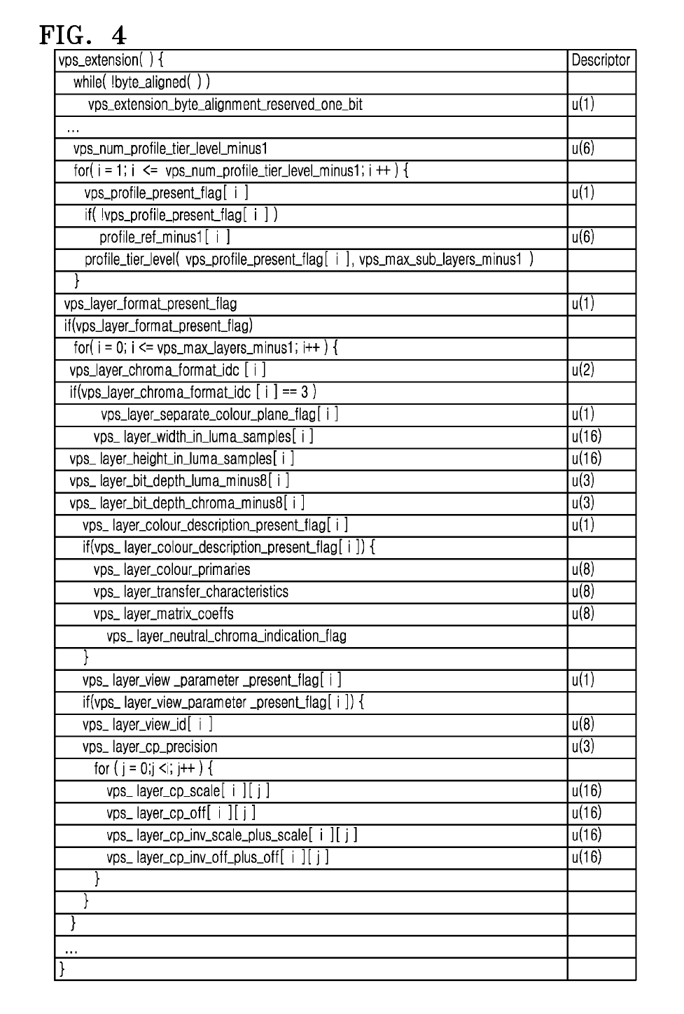

The VPS may include an extended structure. The VPS may use an extension flag to indicate the existence of an extended structure. The video decoding apparatus 20 may check whether the VPS is extended, by using a vps_extension_flag. When the value of a vps_extension_flag is 1, the VPS may determine to include an extended structure, and acquire Information according to the extended structure of the VPS from the bitstream. For example, to acquire the information according to the extended structure of the VPS from the bitstream, the video decoding apparatus 20 may acquire a VPS extension parameter from the bitstream according to the VPS extended structure by using the syntax of FIG. 4.

FIG. 4 is a diagram illustrating a VPS extension syntax, according to an embodiment. A method of acquiring a video format parameter, which is performed by the video decoding apparatus 20, according to an embodiment is described with reference to FIG. 4.

As illustrated in FIG. 4, in an encoding/decoding method according to the present embodiment, the video format information may be included in the extended structure of the VPS NAL. In another embodiment, the syntax of FIG. 3B may include the syntax of FIG. 4, and the video format information may be acquired from a VPS basic structure without using the extended structure.

The video decoding apparatus 20 according to the present embodiment may acquire a syntax component from the bitstream according to the illustrated syntax. For example, the video decoding apparatus 20 may determine whether a syntax component is acquired from the bitstream under the control according to a control pseudocode such as “if” and “for” of the syntax, and input data read from the bitstream as many as an engineer instructed to a variable in a pseudocode with respect to the variable indicated by the engineer.

For example, in a vps_layer_format_present_flag of the syntax of FIG. 4, the video decoding apparatus 20 reads data from the bitstream as much as u(1) and input the read data to the vps_layer_format_present_flag. When the value of vps_layer_format_present_flag is 1 according to the syntax of if(vps_layer_format_present_flag), a syntax component is read from the bitstream according to the syntax in the if clause. When the value is 0, the syntax in the if clause is not performed.

A method of acquiring a video format parameter syntax component from a bitstream, which is performed by the video decoding apparatus 20, according to the present embodiment is described below with reference to FIG. 4. The video decoding apparatus 20 according to the present embodiment may acquire syntax components described below, from the bitstream, as illustrated in FIG. 4.

The vps_layer_format_present_flag is information indicating whether a video format related to the syntax is supplied in a VPS extension, and may be expressed by a 1 bit flag. When the value of the vps_layer_format_present_flag is 1, the video decoding apparatus 20 according to the present embodiment acquires from the bitstream video format information related to the syntax described below. When the value of the vps_layer_format_present_flag is 0, the video decoding apparatus 20 does not acquire the video format information related to the syntax described below from the bitstream and acquires pieces of information different from the syntax.

A vps_layer_chroma_format_idc[i] specifies chroma sampling regarding luma sampling with respect to a layer having an i-th layer index as shown in Table 1 below. The layer index i has an integer value between 0 and (the maximum layer number in vps−1). The value of vps_layer_chroma_format_idc[i] includes a real number between 0 and 3.

TABLE 1

| vps_lay- | vps_layer_sep- | | Sub- | Sub- |
|---|---|---|---|---|
| er_chroma_for- | arate_col- | Chroma | Width | Height |
| mat_idc | our_plane_flag | format | C | C |
| 0 | 0 | monochrome | 1 | 1 |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

When the value of the vps_layer_separate_colour_plane_flag[i] is 1, it may be seen that each of three color components of a 4:4:4 chroma format is encoded with respect to a layer having an index i. When the value of the vps_layer_separate_colour_plane_{—} flag[i] is 0, it may be seen that each of three color components of a 4:4:4 chroma format is not coded with respect to the layer having an index i. When the value of the vps_layer_separate_colour_plane_{—} flag[i] is not supplied, the value may be regarded to be 0. When the value of the vps_layer_separate_colour_plane_{—} flag[i] is 1, an encoded picture with respect to the layer having an index I includes three components. Each component may include coded samples of one color plane (Y, Cb, or Cr) and use a single color coding syntax.

A vps_layer_width_in_luma_samples[i] indicates a width of each coded picture in the luma samples with respect to the layer having an index i. The value of the vps_layer_width_in_luma_samples [i] may not be 0.

A vps_layer_height_in_luma_samples [i] indicates a height of each coded picture in the luma samples with respect to the layer having an index i. The value of the vps_layer_height_in_luma_samples [i] may not be 0.

A vps_layer_bit_depth_luma_minus8[i]+8 indicates below a bit depth of samples of a luma array with respect to the layer having an index i. A bit depth signifies the number of bits expressing a sample. The video decoding apparatus 20 may determine the number of bits expressing a luma sample value by using a vps_layer_bit_depth_luma_minus8[i] as Equation 1 below.

For example, when the value of the vps_layer_bit_depth_luma_minus8[i] is 0, the video decoding apparatus 20 may determine a bit length indicating the luma sample value of the i-th layer to be 8. When the value of the vps_layer_bit_depth_luma_minus8[i] is 4, the video decoding apparatus 20 may determine a bit length indicating the luma sample value of the i-th layer to be 12.

BitDepthL_{Y}[i]=8+vps_layer_bit_depth_luma_minus8[i] [Equation 1]

The vps_layer_bit_depth_luma_minus8[i] may be an integer between 0 and 6.

A vps_layer_bit_depth_chroma_minus8[i]+8 indicates a bit depth of samples in a chroma array with respect to the layer having an index i as below. The video decoding apparatus 20 may determine a bit length expressing a chroma sample value of the i-th layer by using the vps_layer_bit_depth_chroma_minus8[i] as shown in Equation 2 below.

BitDepthL_{C}[i]=8+vps_layer_bit_depth_chroma_minus8[i] [Equation 2]

The vps_layer_bit_depth_chroma_minus8[i] may be an integer between 0 and 6.

A vps_layer_colour_description_present_flag indicates chromaticity information, transfer characteristics information, and information indicating whether a matrix coefficient is supplied, which may be expressed by a 1-bit flag.

For example, when the value of the vps_layer_colour_description_present_flag is 1, the vps_layer_colour_description_present_flag indicates that colour_primaries, transfer_characteristics, and matrix_coeffs are supplied. When the value of the colour_description_present_flag is 0, the vps_layer_colour_description_present_flag indicates that colour_primaries, transfer_characteristics, and matrix_coeffs are not supplied.

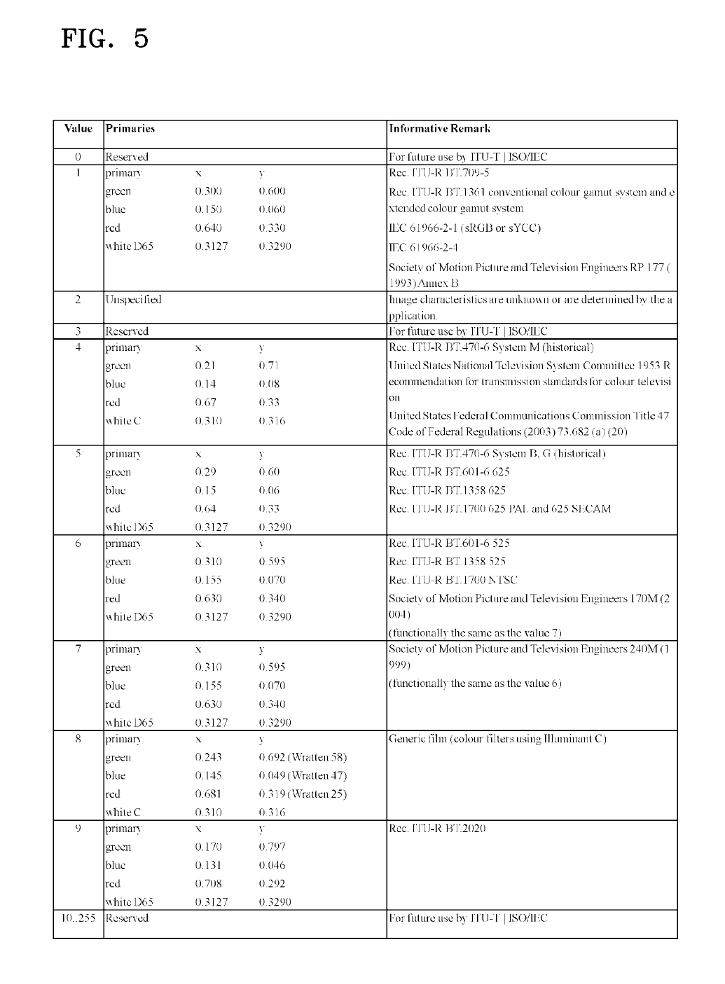

A vps_layer_colour_primaries [i] indicates chromaticity coordinates of a source primary described in Table E-3 in terms of the CIE 1931 definition of x and y in the ISO 11664-1 with respect to the i-th layer. FIG. 5 is a diagram illustrating chromaticity coordinates used by an encoding apparatus, according to an embodiment. For example, the video decoding apparatus 20 according to the present embodiment may use the chromaticity coordinates of FIG. 5 as the chromaticity coordinates of a source primary.

When a colour_primaries syntax component is not supplied, the value of colour_primaries may be inferred to be 2. Referring to a table of FIG. 5, when the value of colour_primaries is 2, it may be seen that chromaticity is not defined or may be determined by an application. The value of colour_primaries indicated to be reserved in Table E-3 is a reserved value to be used later. The video decoding apparatus 20 may interprets that the reserved value of the colour_primaries is 2.

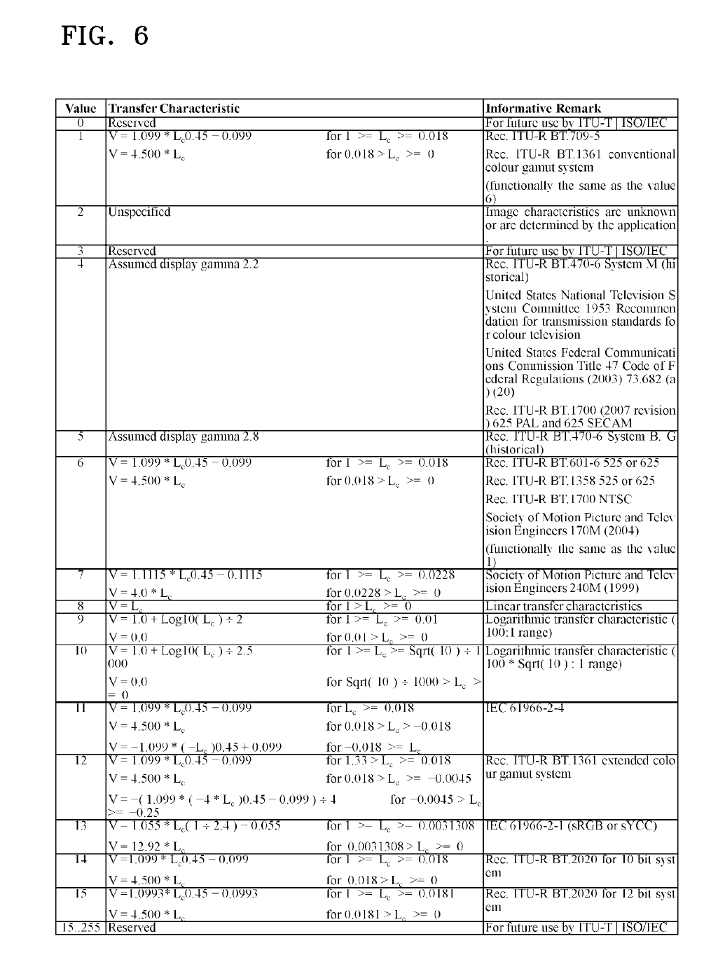

A vps_layer_transfer_characteristics[i] indicates photoelectric transfer characteristics of a source picture as shown in a table of FIG. 6 with respect to the i-th layer. FIG. 6 illustrates a function of a linear optical intensity input L_{C} in a range of a real number between 0 and 1 according to the value of vps_layer_transfer_characteristics[i].

When a transfer_characteristics syntax component is not supplied, the value of transfer_characteristics is inferred to be 2. As illustrated in FIG. 6, the value “2” indicates that transfer characteristics are not specified or determined by an application.

In a table of FIG. 6, the transfer_characteristics identified to be reserved is reserved to be used later. When the value of the transfer_characteristics is a reserved value, the video decoding apparatus 20 may interpret and process the value to be 2.

A vps_layer_matrix_coeffs [i] indicates matrix coefficients used to induce luma and chroma signals from green, blue, and red primaries with respect to the i-th layer.

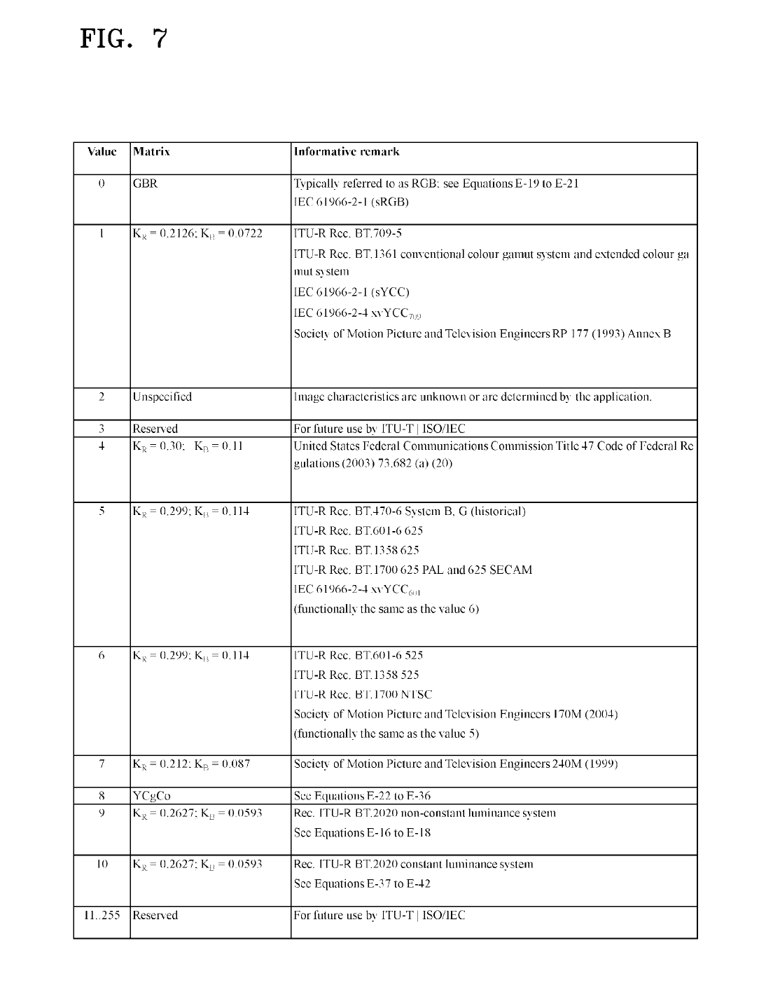

FIG. 7 is a diagram illustrating matrix coefficients used for the induction of luma and chroma signals from green, blue, and red primaries according to the value of a vps_layer_matrix_coeffs. A user of the vps_layer_matrix_coeffs is described with reference to FIG. 7.

Unless a BitDepth_{C} satisfies at least one of the same condition as a BitDepth_{Y} and a condition that a chroma_format_idc is the same as 3 (4:4:4), a value of a matrix_coeffs is not set to 0. In another condition, the value “0” of the matrix_coeffs is reserved for a future use.

Unless the BitDepth_{C} satisfies at least one of the same condition as the BitDepth_{Y} and a condition that the BitDepth_{C} is the same as BitDepth_{Y}+1 and the chroma_format_idc is the same as 3 (4:4:4), the value of the matrix_coeffs is not set to 8. In another condition, the value “8” of the matrix_coeffs is reserved for a future use.

When a matrix_coeffs syntax component is not supplied, the video decoding apparatus 20 may infer the value of the matrix_coeffs to be 2. As illustrated in Table 7, the value “2” signifies that the transfer characteristics are not specified.

In the following description, a method of interpreting the matrix_coeffs with the colour_primaries and the transfer_characteristics is described. ER, EG, and BE are defined to be signals of “linear-domain” real number values based on the color primaries prior to the application of a transfer characteristics function.

The application of a transfer characteristics function is indicated by (x)′ with respect to a factor x. Signals E′R, E′G, and E′B are determined by the application of a transfer characteristics function as below.

E′R=(ER)′ (E-1)

E′G=(EG)′ (E-2)

E′B=(EB)′ (E-3)

The ranges of E′R, E′G, and E′B are specified as below.
If the transfer_characteristics is not 11 or 12, the E′R, E′G, and E′B are real numbers between 0 and 1.
Otherwise, that is, if the transfer_characteristics is 11 (IEC 61966-2-4) or 12 (Rec. ITU-R BT.1361 extended colour gamut system), the E′R, E′G, and E′B are real numbers in a large range that is not specified herein.

Nominal white is specified to be ER having a value of “1”, E′G having a value of “1”, and E′B having a value of “1”.

Nominal black is specified to be ER having a value of “0”, E′G having a value of “0”, and EB having a value of “0”.

The interpretation of the matrix_coeffs is specified as below.
If a video_full_range_flag is 0, the following is applied to the interpretation.
If the matrix_coeffs is 1, 4, 5, 6, 7, 9, or 10, the following equations are applied to the interpretation.

Y=Clip1_{Y}(Round((1<<(BitDepth_{Y}−8))*(219*E′_{Y}+16))) (E-4)

Cb=Clip1_{C}(Round((1<<(BitDepth_{C}−8))*(224*E′_{PB}+128))) (E-5)

Cr=Clip1_{C}(Round((1<<(BitDepth_{C}−8))*(224*E′_{PR}+128))) (E-6)
Otherwise, that is, if the matrix_coeffs is 0 or 8, the following equations are applied to the interpretation.

R=Clip1_{Y}((1<<(BitDepth_{Y}−8))*(219*E′_{R}+16)) (E-7)

G=Clip1_{Y}((1<<(BitDepth_{Y}−8))*(219*E′_{G}+16)) (E-8)

B=Clip1_{Y}((1<<(BitDepth_{Y}−8))*(219*E′_{B}+16)) (E-9)
Otherwise, that is, if the matrix_coeffs is 2, the interpretation of the matrix_coeffs syntax component may not be unknown or determined by an application.
Otherwise, that is, if the matrix_coeffs is not 0, 1, 2, 4, 5, 6, 7, 8, 9, or 10, the interpretation of the matrix_coeffs syntax component is reserved for a future use.
Otherwise, that is, if the video_full_range_flag is 1, the following is applied to the interpretation.
If the matrix_coeffs is 1, 4, 5, 6, 7, 9 or 10, the following equations are applied to the interpretation.

Y=Clip1_{Y}(Round(((1<<BitDepth_{Y})−1)*E′_{Y})) (E-10)

Cb=Clip1_{C}(Round(((1<<BitDepth_{C})−1)*E′_{PB}+(1<<(BitDepth_{C}−1)))) (E-11)

Cr=Clip1_{C}(Round(((1<<BitDepth_{C})−1)*E′_{PR}+(1<<(BitDepth_{C}−1)))) (E-12)
Otherwise, that is, if the matrix_coeffs is 0 or 8, the following is applied to the interpretation.

R=Clip1_{Y}(((1<<BitDepth_{Y})−1)*E′_{R}) (E-13)

G=Clip1_{Y}(((1<<BitDepth_{Y})−1)*E′_{G}) (E-14)

B=Clip1_{Y}(((1<<BitDepth_{Y})−1)*E′_{B}) (E-15)
Otherwise, that is, if the matrix_coeffs is 2, the interpretation of the matrix_coeffs syntax component may be unknown or determined by an application.
Otherwise, that is, if the matrix_coeffs is not 0, 1, 2, 4, 5, 6, 7, 8, 9, or 10, the interpretation of the matrix_coeffs syntax component is reserved for a future use. The reserved value of the matrix_coeffs may not be written to the bitstream, and the video decoding apparatus 20 may interpret the reserved value of the matrix_coeffs to be 2.

Variables E′_{Y}, E′_{PB}, and E′_{PR} (with respect to the matrix_coeffs having a value that is not 0 or 8) or Y, Cb, and Cr (with respect to the matrix_coeffs having a value that is 0 or 8) are specified as below.
If the matrix_coeffs is not 0, 8, or 10, the following is applied to the interpretation:

E′_{Y}=K_{R}*E′_{R}+(1−K_{R}−K_{B})*E′_{G}+K_{B}*E′_{B} (E-16)

E′_{PB}=0.5*(E′_{B}−E′_{Y})/(1−K_{B}) (E-17)

E′_{PR}=0.5*(E′_{R}−E′_{Y})/(1−K_{R}) (E-18)

E′_{Y} is a real number having a value “0” with respect to the nominal black and a value “1” with respect to nominal white.

E′_{PB} and E′_{PR} are real numbers having a value of “0” with respect to both the nominal black and the nominal white.

If the transfer_characteristics is not 11 or 12, E′_{Y} is a real number having a value between 0 and 1. If the transfer_characteristics is not 11 or 12, E′_{PB} and E′_{PR} are real numbers having a value between −0.5 and 0.5.

If the transfer_characteristics is 11(IEC 61966-2-4) or 12(ITU-R BT.1361 extended color gamut system), E′_{Y}, E′_{PB}, and E′_{PR} are real numbers having a range larger than the value specified herein.
Otherwise, that is, if the matrix_coeffs is 0, the following is applied to the interpretation:

Y=Round(G) (E-19)

Cb=Round(B) (E-20)

Cr=Round(R) (E-21)
Otherwise, that is, if the matrix_coeffs is 8, the following is applied to the interpretation.
If the BitDepth_{C} is the same as the BitDepth_{Y}, the following is applied to the interpretation:

Y=Round(0.5*G+0.25*(R+B)) (E-22)

Cb=Round(0.5*G−0.25*(R+B))+(1<<(BitDepth_{C}−1)) (E-23)

Cr=Round(0.5*(R−B))+(1<<(BitDepth_{C}−1)) (E-24)

For the purpose of the YCgCo nomenclature used in FIG. 7, Cb and Cr of Equations E-23 and E-24 may be respectively referred to as Cg and Co. The inverse transform of three equations may be calculated as follows.

t=Y−(Cb−(1<<(BitDepth_{C}−1))) (E-25)

G=Clip1_{Y}(Y+(Cb−(1<<(BitDepth_{C}−1)))) (E-26)

B=Clip1_{Y}(t−(Cr−(1−(BitDepth_{C}−1)))) (E-27)

R=Clip1_{Y}(t+(Cr−(1<<(BitDepth_{C}−1)))) (E-28)
Otherwise, that is, if the BitDepth_{C} is not the same as the BitDepth_{Y}, the following is applied to the interpretation.

Cr=Round(R)−Round(B)+(1<<(BitDepth_{C}−1)) (E-29)

t=Round(B)+((Cr−(1<<(BitDepth_{C}−1)))>>1) (E-30)

Cb=Round(G)−t+(1<<(BitDepth_{C}−1)) (E-31)

Y=t+((Cb−(1<<(BitDepth_{C}−1)))>>1) (E-32)

For the purpose of the YCgCo nomenclature used in FIG. 7, Cb and Cr of Equations of E-31 and E-29 may be respectively referred to as Cg and Co. The inverse transform of the four equations may be calculated as follows.

t=Y−((Cb−(1<<(BitDepth_{C}−1)))>>1) (E-33)

G=Clip1_{Y}(t+(Cb−(1<<(BitDepth_{C}−1)))) (E-34)

B=Clip1_{Y}(t−((Cr−(1<<(BitDepth_{C}−1)))>>1)) (E-35)

R=Clip1_{Y}(B+(Cr−(1<<(BitDepth_{C}−1)))) (E-36)
Otherwise, that is, if the matrix_coeffs is 10, the following is applied to the interpretation:

E_{Y}=K_{R}*E_{R}+(1−K_{R}−K_{B})*E_{G}+K_{B}*E_{B} (E-37)

E′_{Y}=(E_{Y})′ (E-38)

In the present embodiment, prior to the application of the transfer characteristics function, E_{Y} is defined from the “linear-domain” signals for E_{R}, E_{G}, and E_{B}, and then, the transfer characteristics function is used to generate the signal E′_{Y}. E_{Y} and E′_{Y} are similar to each other in the value “0” related to the nominal black and the value “1” related to the nominal white.

E′PB=(E′B−E′Y)/1.9404 for −0.9702<=E′B−E′Y<=0 (E-39)

E′PB=(E′B−E′Y)/1.5816 for 0<E′B−E′Y<=0.7908 (E-40)

E′PR=(ER−E′Y)/1.7184 for −0.8592<=ER−E′Y<=0 (E-41)

E′PR=(ER−E′Y)/0.9936 for 0<E′R−E′Y<=0.4968 (E-42)

If the value of the neutral_chroma_indication_flag is 1, values of all decoded chroma samples are that 1<<(BitDepthL_{C}−1). If the value is 1, all values of the decoded chroma samples generated by performing decoding may be that 1<<

(BitDepthL_{C}−1). If the value if 0, no decoded chroma sample value is indicated. When no value is supplied, the value is inferred to be 0.

A vps_layer_cp_precision indicates precision of a vps_layer_cp_scale[i], a vps_layer_cp_off[i], a vps_layer_cp_inv_scale_plus_scale[i], and a vps_layer_cp_inv_off_plus_off[i]. The value of the vps_layer_cp_precision may be an integer between 0 and 5.

The vps_layer_cp_scale[i], the vps_layer_cp_off[i], the vps_layer_cp_inv_scale_plus_scale[i], and the vps_layer_cp_inv_off_plus_off[i] specify transform parameters to transform a depth value to a disparity value.

For example, the video decoding apparatus 20 may determine a disparity by using a depth value of a depth image using the following equation.

Disparity vector=(s*depth value+o,0)

For convenience of explanation, a y component of the disparity, that is, a vertical component is assumed to be 0. In other words, it is assumed that the position of an object in a multi-view image is changed horizontally only according to a change in a viewpoint. An x component of the disparity may be calculated by multiplying a depth value by “s” and adding “o” thereto. The “s” is a scale factor. The depth value signifies a depth value of a particular pixel in a depth image. The “o” signifies an offset. The scale factor and the offset may be determined from a camera parameter with respect to a layer image to be referred to. For example, the camera parameter may include a focal length of a camera and baseline information. The baseline information of a camera signifies information about a distance between lenses of the camera. The video decoding apparatus 20 may use the vps_layer_cp_scale[i] as the scale factor and the vps_layer_cp_off[i] as the offset.

The video encoding and decoding methods performed by the above-described video encoding and decoding apparatuses may be employed in interlayer video encoding and decoding apparatuses to encode and decode interlayer video. The interlayer video encoding apparatuses according to various embodiments Hmay classify a plurality of image sequences by layers according to a scalable video coding method and encode each of the classified image sequences, and output a separate stream including data encoded by layers. The interlayer video encoding apparatus may encode a first layer image sequence and a second layer image sequence to be different layers.

A first layer encoder may encode first layer images and output a first layer stream including coded data of the first layer images.

A second layer encoder may encode second layer images and output a second layer stream including coded data of the second layer images.

For example, according to the scalable video coding method based on spatial scalability, low-resolution images may be encoded as the first layer images and high-resolution images may be encoded as the second layer images. A result of the encoding of the first layer images may be output as a first layer stream, and a result of the encoding of the second layer images may be output as a second layer stream.

In another example, a multi-view video may be encoded according to the scalable video coding method. Left-viewpoint images may be encoded as the first layer images, and right-viewpoint images may be encoded as the second layer images. Central-viewpoint images, left-viewpoint images, and right-viewpoint images may be encoded. Among the images, the central-viewpoint images may be encoded as the first layer images, the left-viewpoint images may be encoded as the first and second layer images, and the right-viewpoint images may be encoded as the second layer images.

In another example, a scalable video coding method may be performed according to a temporal hierarchical prediction based on temporal scalability. A first layer stream including coding information generated by encoding images of a basic frame rate may be output. A temporal level is classified by frame rates and each temporal frame may be encoded as each layer. Images of a fast frame rate are further encoded referring to images of the basic frame rate, and a second layer stream including coding information of a fast frame rate may be output.

Furthermore, the scalable video coding may be performed on a first layer and a plurality of second layers. When there are three or more second layers, first layer images and 1^{st} second layer images, 2^{nd} second layer images, . . . , K-th second layer images may be encoded. Accordingly, a result of the encoding of the first layer images may be output as a first layer stream, and results of the encoding of the 1^{st}, the 2^{nd}, . . . , the K-th second layer images may be respectively output as 1st, 2^{nd}, . . . , K-th second layer streams.

The interlayer video encoding apparatuses according to various embodiments may perform inter-prediction of predicting a current image by referring to images of a single layer. A motion vector indicating motion information between a current image and a reference image, and a residual component between the current image and the reference image, may be generated through the inter-prediction.

Furthermore, the interlayer video encoding apparatus may perform interlayer prediction of predicting the second layer images by referring to the first layer images.

Furthermore, when an interlayer video encoding apparatus according to an embodiment allows three or more layers, for example, a first layer, a second layer, and a third layer, interlayer prediction between the first layer image and the third layer image, and interlayer prediction between the second layer image and the third layer image, may be performed according to a multilayer prediction structure.

A positional difference component between a current image and a reference image of another layer, and a residual component between the current image and the reference image of another layer, may be generated through the interlayer prediction.

The interlayer video encoding apparatuses according to various embodiments encode each image of a video for each layer by blocks. A block type may include a square or a rectangle, or may be a certain geometric shape, but not limited to a data unit of a certain size. A block may be a largest coding unit, a coding unit, a prediction unit, or a transform unit, among coding units according to a tree structure. The largest coding units including coding units of a tree structure may be variously named as a coding tree unit, a coding block tree, a block tree, a root block tree, a coding tree, a coding root, or a tree trunk. A video encoding/decoding method based on coding units according to a tree structure is described referring to FIGS. 8 to 20.

The inter-prediction and the interlayer prediction may be performed based on a data unit such as a coding unit, a prediction unit, or a transform unit. In a video encoding apparatus according to an embodiment and a video decoding apparatus according to an embodiment, blocks by which video data is divided are divided by coding units of a tree structure, and the coding units, the prediction units, and the transform units may be used for interlayer prediction or inter-prediction of a coding unit. A video encoding method and an apparatus thereof, and a video decoding method and an apparatus thereof, based on a coding unit of a tree structure and a transform unit, according to embodiments, are described below with reference to FIGS. 8 to 20.

In an encoding/decoding process for a multilayer video, an encoding/decoding process for first layer images and an encoding/decoding process for second layer images are basically separately performed. In other words, when interlayer prediction is generated in a multilayer video, results of encoding/decoding a single layer video may be referred to each other, but a separate encoding/decoding process is generated for each single layer video.

Accordingly, for convenience of explanation, since a video encoding process and a video decoding process based on a coding unit of a tree structure, which are described later with reference to FIGS. 8 to 20, are a video encoding process and a video decoding process for a single layer video, inter-prediction and motion compensation are described in detail.

Accordingly, in order for an encoder of an interlayer video encoding apparatus according to an embodiment to encode a multilayer video based on a coding unit of a tree structure, to perform video encoding for each single layer video, a video encoding apparatus 800 of FIG. 8 may be controlled to be included as many as the number of layers of the multilayer video to encode a single layer video assigned to each video encoding apparatus 800. Furthermore, the interlayer video encoding apparatus may perform prediction between viewpoints using results of the encoding of a separate single viewpoint by each video encoding apparatus 800. Accordingly, the encoder of the interlayer video encoding apparatus may generate a basic viewpoint video stream and a second layer video stream including the encoding result for each layer.

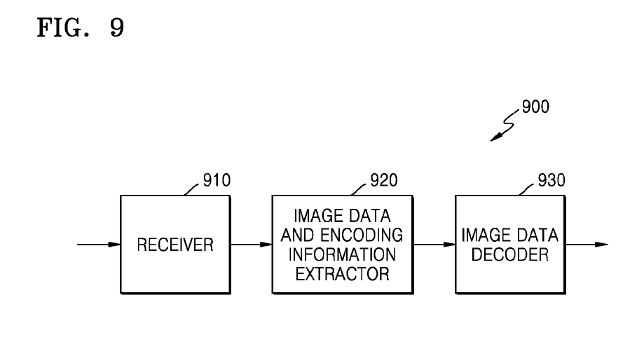

Similarly, in order for a decoder of an interlayer video decoding apparatus according to an embodiment to decode a multilayer video based on a coding unit of a tree structure, to perform video decoding on received first layer and second layer video streams for each layer, a video decoding apparatus 900 of FIG. 9 may be controlled to be included as many as the number of layers of the multilayer video to decode a single layer video assigned to each video decoding apparatus 900. Furthermore, the interlayer video decoding apparatus may perform interlayer compensation using results of the decoding of a separate single by each video decoding apparatus 900. Accordingly, the decoder of the interlayer video decoding apparatus may generate first layer images and second layer images reconstructed for each layer.

FIG. 8 is a block diagram of the video encoding apparatus 800 based on coding units according to a tree structure, according to an embodiment.

The video encoding apparatus 800 involving video prediction based on coding units according to a tree structure includes a coding unit determiner 820 and an outputter 830. In the following description, for convenience of explanation, the video encoding apparatus 800 involving video prediction based on coding units according to a tree structure according to an embodiment is shortly referred to as the “video encoding apparatus 800”.

The coding unit determiner 820 may split a current picture based on a largest coding unit (LCU) that is a coding unit having a maximum size for the current picture of an image. If the current picture is larger than the LCU, image data of the current picture may be split into the at least one LCU. The LCU according to an embodiment may be a data unit having a size of 32×32, 64×64, 128×128, 256×256, etc., wherein a shape of the data unit is a square having a width and length in squares of 2.

A coding unit according to an embodiment may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to an embodiment is split according to depths, the image data of the spatial domain included in the LCU may be hierarchically classified according to depths.

A maximum depth and a maximum size of a coding unit, which limit the total number of times a height and a width of the LCU are hierarchically split, may be predetermined.

The coding unit determiner 820 encodes at least one split region obtained by splitting a region of the LCU according to depths, and determines a depth to output a finally encoded image data according to the at least one split region. In other words, the coding unit determiner 820 determines a depth by encoding the image data in the deeper coding units according to depths, according to the LCU of the current picture, and selecting a depth having the least encoding error. The determined depth and the encoded image data according to the determined depth are output to the outputter 830.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the depths may differ according to regions in the image data. Thus, one or more depths may be determined in one LCU, and the image data of the LCU may be divided according to coding units of at least one depth.

Accordingly, the coding unit determiner 820 may determine coding units having a tree structure included in the LCU. The “coding units having a tree structure” according to an embodiment include coding units corresponding to a depth determined to be the depth, from among all deeper coding units included in the LCU. A coding unit of a depth may be hierarchically determined according to depths in the same region of the LCU, and may be independently determined in different regions. Similarly, a depth in a current region may be independently determined from a depth in another region.

A maximum depth according to an embodiment is an index related to the number of splitting times from a LCU to an SCU. A first maximum depth according to an embodiment may denote the total number of splitting times from the LCU to the SCU. A second maximum depth according to an embodiment may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transform may be performed according to the LCU. The prediction encoding and the transform are also performed based on the deeper coding units according to a depth equal to or depths less than the maximum depth, according to the LCU.

Since the number of deeper coding units increases whenever the LCU is split according to depths, encoding, including the prediction encoding and the transform, is performed on all of the deeper coding units generated as the depth deepens. For convenience of explanation, the prediction encoding and the transform will now be described based on a coding unit of a current depth, in a LCU.

The video encoding apparatus 800 may variously select a size or shape of a data unit for encoding the image data. In order to encode the image data, operations, such as prediction encoding, transform, and entropy encoding, are performed, and at this time, the same data unit may be used for all operations or different data units may be used for each operation.

For example, the video encoding apparatus 800 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a depth, i.e., based on a coding unit that is no longer split to coding units corresponding to a lower depth. Hereinafter, the coding unit that is no longer split and becomes a basis unit for prediction encoding will now be referred to as a “prediction unit”. A partition obtained by splitting the prediction unit may include a prediction unit or a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition mode include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 800 may also perform the transform on the image data in a coding unit based not only on the coding unit for encoding the image data, but also based on a data unit that is different from the coding unit. In order to perform the transform in the coding unit, the transform may be performed based on a data unit having a size smaller than or equal to the coding unit. For example, the data unit for the transform may include a data unit for an intra mode and a data unit for an inter mode.

The transform unit in the coding unit may be recursively split into smaller sized regions in the similar manner as the coding unit according to the tree structure. Thus, residues in the coding unit may be divided according to the transform unit having the tree structure according to transform depths.

A transform depth indicating the number of splitting times to reach the transform unit by splitting the height and width of the coding unit may also be set in the transform unit. For example, in a current coding unit of 2N×2N, a transform depth may be 0 when the size of a transform unit is 2N×2N, may be 1 when the size of the transform unit is N×N, and may be 2 when the size of the transform unit is N/2×N/2. In other words, the transform unit having the tree structure may be set according to the transform depths.

Encoding information according to coding units corresponding to a depth requires not only information about the depth, but also about information related to prediction encoding and transform. Accordingly, the coding unit determiner 820 not only determines a depth having a least encoding error, but also determines a partition mode in a prediction unit, a prediction mode according to prediction units, and a size of a transform unit for transform.

Coding units according to a tree structure in a LCU and methods of determining a prediction unit/partition, and a transform unit, according to an embodiment, will be described in detail below with reference to FIGS. 9 through 19.

The coding unit determiner 820 may measure an encoding error of deeper coding units according to depths by using Rate-Distortion Optimization based on Lagrangian multipliers.

The outputter 830 outputs the image data of the LCU, which is encoded based on the at least one depth determined by the coding unit determiner 820, and information about the encoding mode according to the depth, in bitstreams.

The encoded image data may be obtained by encoding residual data of an image.

The information about splitting according to depths may include information about the depth, about the partition mode in the prediction unit, the prediction mode, and splitting of the transform unit.

The final depth information may be defined by using splitting information according to depths, which indicates whether encoding is performed on coding units of a lower depth instead of a current depth. If the current depth of the current coding unit is the depth, the current coding unit is encoded by a coding unit of a current depth, and thus the splitting information of the current depth may be defined not to split the current coding unit to a lower depth. Reversely, if the current depth of the current coding unit is not the depth, the encoding using the coding unit of the lower depth is performed, and thus the splitting information of the current depth may be defined to split the current coding unit into the coding units of the lower depth.

If the current depth is not the depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and at least one splitting information is determined for a coding unit of a depth, the at least one splitting information may be determined for one LCU. Also, a depth of the image data of the LCU may be different according to locations since the image data is hierarchically split according to depths, and thus splitting information may be set for the image data.

Accordingly, the outputter 830 may assign corresponding splitting information to at least one of the coding unit, the prediction unit, and a minimum unit included in the LCU.

The minimum unit according to an embodiment is a square data unit obtained by splitting the SCU constituting the lowermost depth by 4. Alternatively, the minimum unit according to an embodiment may be a maximum square data unit that may be included in all of the coding units, prediction units, partition units, and transform units included in the LCU.

For example, the encoding information output by the outputter 830 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transform unit permitted with respect to a current video, and information about a minimum size of the transform unit may also be output through a header of a bitstream, a sequence parameter set, or a picture parameter set. The outputter 830 may encode and output reference information related to prediction, prediction information, and slide type information.

In the video encoding apparatus 800, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 800 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transforms, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, in a video encoding apparatus according to an embodiment, image compression efficiency may be increased since a coding unit is adjusted while considering characteristics of an image while increasing a maximum size of a coding unit while considering a size of the image.

The interlayer video encoding apparatus including the structure described with reference to FIG. 1A may include as many video encoding apparatuses 800 as the number of layers in order to encode single-layer images for respective layers of a multi-layer video. For example, the first layer encoder may include a single video encoding apparatus 800 and the second layer encoder may include as many video encoding apparatuses 800 as the number of the second layers.

When the video encoding apparatus 800 encodes first layer images, the coding determiner 820 may determine a prediction unit for inter prediction for each respective coding unit according to a tree structure for each largest coding unit, and may perform inter prediction for each respective prediction unit.

When the video encoding apparatus 800 encodes second layer images, the coding determiner 820 may also determine a prediction unit and a coding unit according to a tree structure for each largest coding unit and may perform inter prediction for each respective prediction unit.

The video encoding apparatus 800 may encode a brightness difference between first and second layer images for compensating for the brightness difference. However, whether to perform brightness compensation may be determined according to an encoding mode of a coding unit. For example, the brightness compensation may be performed only on a prediction unit of 2N×2N.

FIG. 9 is a block diagram of the video decoding apparatus 900 based on coding units having a tree structure, according to an embodiment.

The video decoding apparatus 900 that involves video prediction based on coding units having a tree structure includes a receiver 910, an image data and encoding information extractor 920, and an image data decoder 930. In the following description, for convenience of explanation, the video decoding apparatus 900 involving video prediction based on coding units according to a tree structure according to an embodiment is shortly referred to as the “video decoding apparatus 900”.

Definitions of various terms, such as a coding unit, a depth, a prediction unit, a transform unit, and information about various encoding modes, for decoding operations of the video decoding apparatus 900 are identical to those described with reference to FIG. 8 and the video encoding apparatus 800.

The receiver 910 receives and parses a bitstream of an encoded video. The image data and encoding information extractor 920 extracts encoded image data for each coding unit from the parsed bitstream, wherein the coding units have a tree structure according to each LCU, and outputs the extracted image data to the image data decoder 930. The image data and encoding information extractor 920 may extract information about a maximum size of a coding unit of a current picture, from a header about the current picture, a sequence parameter set, or a picture parameter set.

Also, the image data and encoding information extractor 920 extracts splitting information and encoding information for the coding units having a tree structure according to each LCU, from the parsed bitstream. The extracted splitting information and encoding information are output to the image data decoder 930. In other words, the image data in a bit stream is split into the LCU so that the image data decoder 930 decodes the image data for each LCU.

The splitting information and encoding information according to the LCU may be set for at least one piece of splitting information corresponding to the depth, and encoding information according to the depth may include information about a partition mode of a corresponding coding unit corresponding to the depth, information about a prediction mode, and splitting information of a transform unit. Also, splitting information according to depths may be extracted as the information about a final depth. The splitting information and the encoding information according to each LCU extracted by the image data and encoding information extractor 920 is splitting information and encoding information determined to generate a minimum encoding error when an encoder, such as the video encoding apparatus 800, repeatedly performs encoding for each deeper coding unit according to depths according to each LCU. Accordingly, the video decoding apparatus 900 may reconstruct an image by decoding the image data according to a depth and an encoding mode that generates the minimum encoding error.

Since the splitting information and the encoding information may be assigned to a predetermined data unit from among a corresponding coding unit, a prediction unit, and a minimum unit, the image data and encoding information extractor 920 may extract the splitting information and the encoding information according to the predetermined data units. If splitting information and encoding information of a corresponding LCU are recorded according to predetermined data units, the predetermined data units to which the same splitting information and encoding information are assigned may be inferred to be the data units included in the same LCU.

The image data decoder 930 reconstructs the current picture by decoding the image data in each LCU based on the splitting information and the encoding information according to the LCUs. In other words, the image data decoder 930 may decode the encoded image data based on the extracted information about the partition mode, the prediction mode, and the transform unit for each coding unit from among the coding units having the tree structure included in each LCU. A decoding process may include a prediction including intra prediction and motion compensation, and an inverse transform.

The image data decoder 930 may perform intra prediction or motion compensation according to a partition and a prediction mode of each coding unit, based on the information about the partition mode and the prediction mode of the prediction unit of the coding unit according to depths.

In addition, the image data decoder 930 may read information about a transform unit according to a tree structure for each coding unit so as to perform inverse transform based on transform units for each coding unit, for inverse transform for each LCU. Via the inverse transform, a pixel value of the spatial domain of the coding unit may be reconstructed.

The image data decoder 930 may determine a final depth of a current LCU by using splitting information according to depths. If the splitting information indicates that image data is no longer split in the current depth, the current depth is the final depth. Accordingly, the image data decoder 930 may decode encoded data in the current LCU by using the information about the partition mode of the prediction unit, the information about the prediction mode, and the splitting information of the transform unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 930 in the same encoding mode. As such, the current coding unit may be decoded by obtaining the information about the encoding mode for each coding unit.

The interlayer video decoding apparatus including the structure described with reference to FIG. 2A may include as many video decoding apparatuses 900 as the number of views in order to decode the received first layer image stream and second layer image stream to reconstruct first layer images and second layer images.

When a first layer image stream is received, the image data decoder 930 of the video decoding apparatus 900 may split samples of first layer images that are extracted from the first layer image stream by the extractor 920 into coding units according to a tree structure of a largest coding unit. The image data decoder 930 may perform motion compensation on respective prediction units for inter prediction for each respective coding unit according to a tree structure of the samples of the first layer images, to reconstruct the first layer images.

When a second layer image stream is received, the image data decoder 930 of the video decoding apparatus 900 may split samples of second layer images that are extracted from the second layer image stream by the extractor 920 into coding units according to a tree structure of a largest coding unit. The image data decoder 930 may perform motion compensation on respective prediction units for inter prediction of the samples of the second layer images to reconstruct the second layer images.

The extractor 920 may obtain information relating to a brightness order between first and second layer images from a bitstream in order to compensate for the brightness difference. However, whether to perform brightness compensation may be determined according to an encoding mode of a coding unit. For example, the brightness compensation may be performed only on a prediction unit of 2N×2N.

The video decoding apparatus 900 may obtain information about at least one coding unit that generates the minimum encoding error when encoding is recursively performed for each largest coding unit, and may use the information to decode the current picture. In other words, the coding units having the tree structure determined to be the optimum coding units in each largest coding unit may be decoded. Also, the maximum size of a coding unit is determined considering a resolution and an amount of image data.

Accordingly, even if image data has high resolution and a large amount of data, the image data may be efficiently decoded and reconstructed by using a size of a coding unit and an encoding mode, which are adaptively determined according to characteristics of the image data, by using information about an optimum encoding mode received from an encoder.

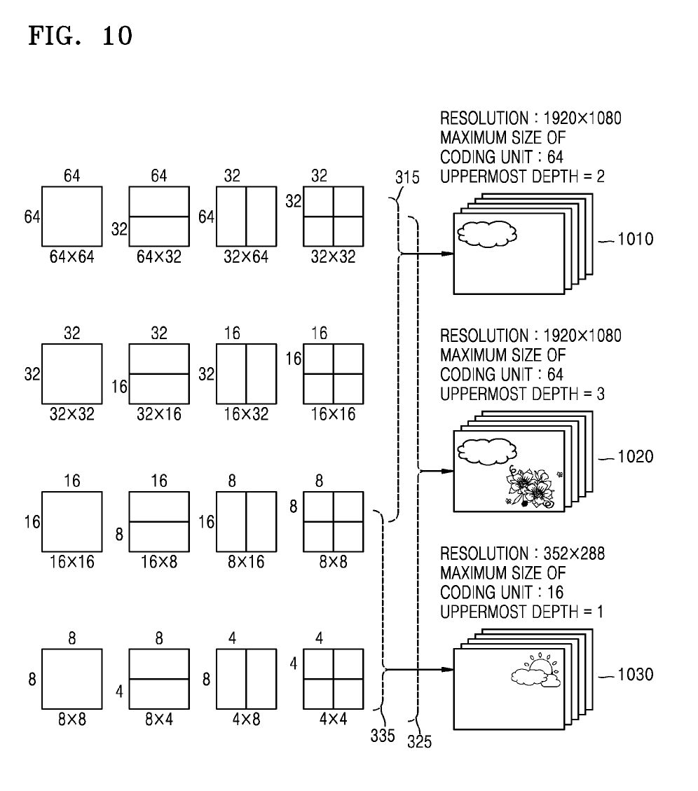

FIG. 10 is a diagram for describing a concept of coding units according to various embodiments.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 1010, a resolution is 1920x1080, a maximum size of a coding unit is 64, and a maximum depth is 2. In video data 1020, a resolution is 1920x1080, a maximum size of a coding unit is 64, and a maximum depth is 3. In video data 1030, a resolution is 352x288, a maximum size of a coding unit is 16, and a maximum depth is 1. The maximum depth shown in FIG. 10 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 1010 and 1020 having a higher resolution than the video data 1030 may be 64.

Since the maximum depth of the video data 1010 is 2, coding units 1015 of the vide data 1010 may include a LCU having a long axis size of 64, and coding units having long axis sizes of 32 and 16 since depths are deepened to two layers by splitting the LCU twice. Since the maximum depth of the video data 1030 is 1, coding units 1035 of the video data 1030 may include a LCU having a long axis size of 16, and coding units having a long axis size of 8 since depths are deepened to one layer by splitting the LCU once.

Since the maximum depth of the video data 1020 is 3, coding units 1025 of the video data 1020 may include a LCU having a long axis size of 64, and coding units having long axis sizes of 32, 16, and 8 since the depths are deepened to 3 layers by splitting the LCU three times. As a depth deepens, detailed information may be precisely expressed.

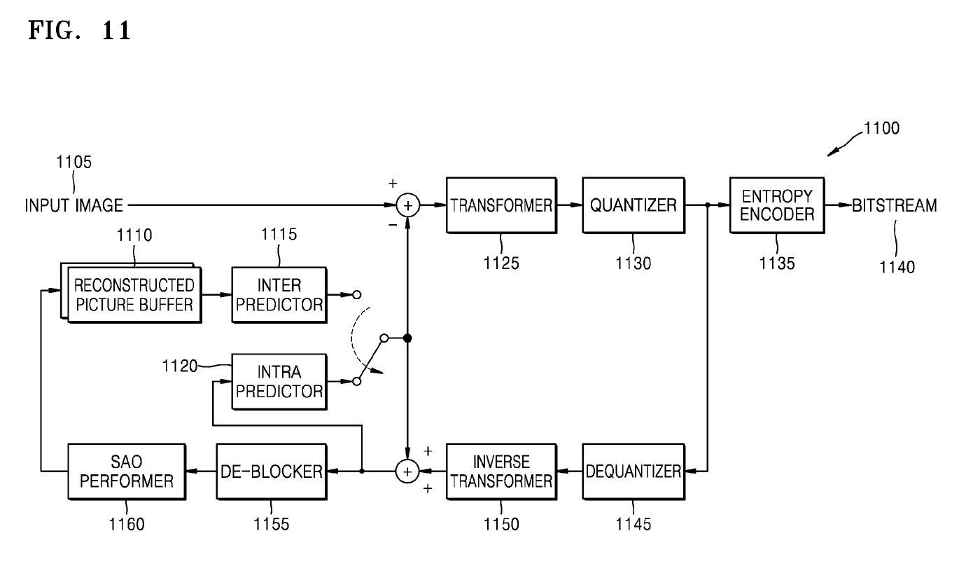

FIG. 11 is a block diagram of a video encoder 1100 based on coding units, according to an embodiment.

The video encoder 1100 performs operations necessary for encoding image data in the coding unit determiner 1520 of the video encoding apparatus 800. In other words, an intra predictor 1120 performs intra prediction on coding units in an intra mode according to prediction units, from among a current frame 1105, and an inter predictor 1115 performs inter prediction on coding units in an inter mode by using a current image 1105 and a reference image obtained from a reconstructed picture buffer 1110 according to prediction units. The current image 1105 may be split into LCUs and then the LCUs may be sequentially encoded. In this regard, the LCUs that are to be split into coding units having a tree structure may be encoded.

Residue data is generated by removing prediction data regarding coding units of each mode that is output from the intra predictor 1120 or the inter predictor 1115 from data regarding encoded coding units of the current image 1105, and is output as a quantized transform coefficient according to transform units through a transformer 1125 and a quantizer 1130. The quantized transform coefficient is reconstructed as the residue data in a spatial domain through a dequantizer 1145 and an inverse transformer 1150. The reconstructed residue data in the spatial domain is added to prediction data for coding units of each mode that is output from the intra predictor 1120 or the inter predictor and thus is reconstructed as data in a spatial domain for coding units of the current image 1105. The reconstructed data in the spatial domain is generated as reconstructed images through a de-blocker 1155 and an SAO performer 1160 and the reconstructed images are stored in the reconstructed picture buffer 1110. The reconstructed images stored in the reconstructed picture buffer 1110 may be used as reference images for inter prediction of another image. The transform coefficient quantized by the transformer 1125 and the quantizer 1130 may be output as a bitstream 1140 through an entropy encoder 1135.

In order for the video encoder 1100 to be applied in the video encoding apparatus 800, all elements of the video encoder 1100, i.e., the inter predictor 1115, the intra predictor 1120, the transformer 1125, the quantizer 1130, the entropy encoder 1135, the dequantizer 1145, the inverse transformer 1150, the de-blocker 1155, and the SAO performer 1160, perform operations based on each coding unit among coding units having a tree structure according to each LCU.

Specifically, the intra predictor 1120 and the inter predictor 1115 may determine a partition mode and a prediction mode of each coding unit among the coding units having a tree structure in consideration of a maximum size and a maximum depth of a current LCU, and the transformer 1125 may determine whether to split a transform unit having a quad tree structure in each coding unit among the coding units having a tree structure.

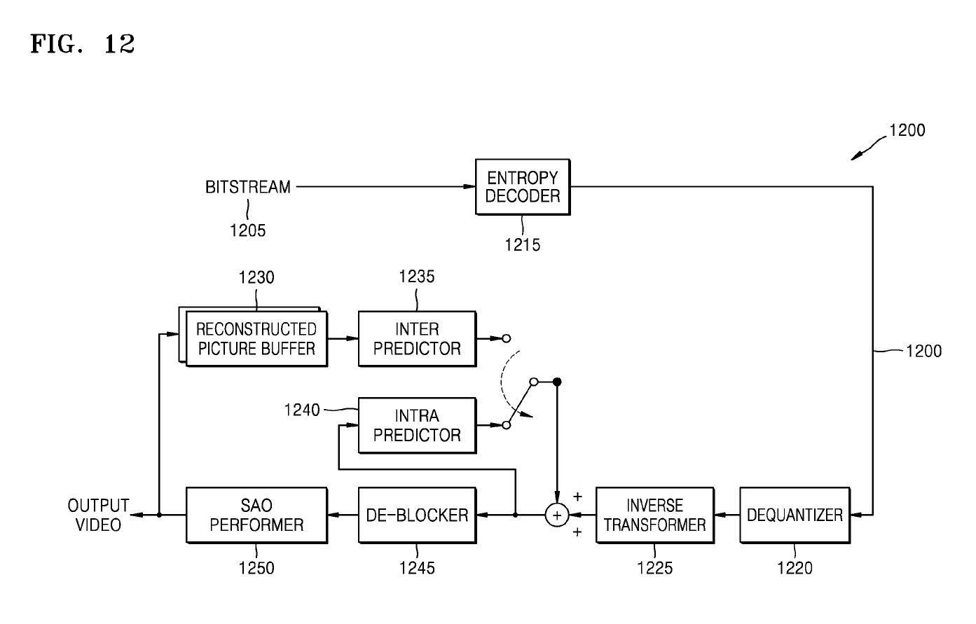

FIG. 12 is a block diagram of a video decoder 1200 based on coding units, according to an embodiment.

An entropy decoder 1215 parses encoded image data to be decoded and information about encoding required for decoding from a bitstream 1205. The encoded image data is a quantized transform coefficient from which residue data is reconstructed by a dequantizer 1220 and an inverse transformer 1225.

An intra predictor 1240 performs intra prediction on coding units in an intra mode according to each prediction unit. An inter predictor 1235 performs inter prediction on coding units in an inter mode from among the current image for each prediction unit by using a reference image obtained from a reconstructed picture buffer 1230.

Prediction data and residue data regarding coding units of each mode, which passed through the intra predictor 1240 and the inter predictor 1235, are summed, and thus data in a spatial domain regarding coding units may be reconstructed, and the reconstructed data in the spatial domain may be output as a reconstructed image 1260 through a de-blocker 1245 and an SAO performer 1250. Reconstructed images stored in the reconstructed picture buffer 1230 may be output as reference images. In order to decode the image data in the image data decoder 930 of the video decoding apparatus 900, operations after the entropy decoder 1215 of the video decoder 1200 according to an embodiment may be performed.

In order for the video decoder 1200 to be applied in the video decoding apparatus 900 according to an embodiment, all elements of the video decoder 1200, i.e., the entropy decoder 1215, the dequantizer 1220, the inverse transformer 1225, the intra predictor 1240, the inter predictor 1235, the de-blocker 1245, and the SAO performer 1250 may perform operations based on coding units having a tree structure for each LCU.

In particular, the intra predictor 1240 and the inter predictor 1235 may determine a partition and a prediction mode for each of the coding units having a tree structure, and the inverse transformer 1225 may determine whether to split a transform unit having a quad tree structure for each of the coding units.

The encoding operation of FIG. 10 and the decoding operation of FIG. 11 describe video stream encoding and decoding operations in a single layer, respectively. Thus, if the encoder of FIG. 1A encodes video streams of two or more layers, the video encoder 1100 may be provided for each layer. Similarly, if the decoder 26 of FIG. 2A decodes video streams of two or more layers, the video decoder 1200 may be provided for each layer.

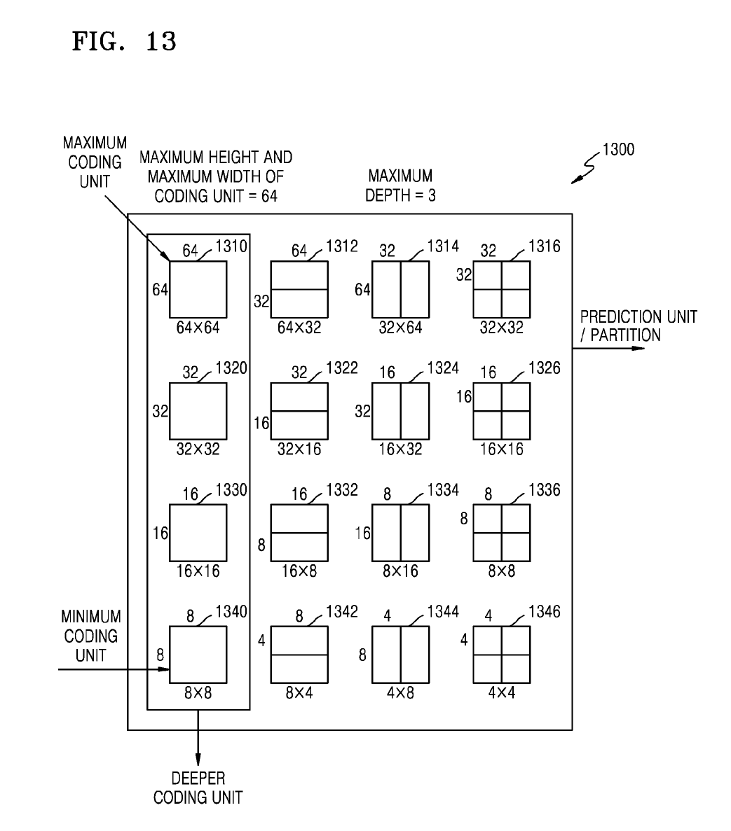

FIG. 13 is a diagram illustrating deeper coding units according to depths, and partitions, according to an embodiment.

The video encoding apparatus 800 and the video decoding apparatus 900 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 1300 of coding units, according to an embodiment, the maximum height and the maximum width of the coding units are each 64, and the maximum depth is 3. In this case, the maximum depth refers to a total number of times the coding unit is split from the LCU to the SCU. Since a depth deepens along a vertical axis of the hierarchical structure 1300, a height and a width of the deeper coding unit are each split. Also, a prediction unit and partitions, which are bases for prediction encoding of each deeper coding unit, are shown along a horizontal axis of the hierarchical structure 1300.

In other words, a coding unit 1310 is a LCU in the hierarchical structure 1300, wherein a depth is 0 and a size, i.e., a height by width, is 64×64. The depth deepens along the vertical axis, and a coding unit 1320 having a size of 32×32 and a depth of 1, a coding unit 1330 having a size of 16×16 and a depth of 2, and a coding unit 1340 having a size of 8×8 and a depth of 3. The coding unit 1340 having a size of 8×8 and a depth of 3 is an SCU.

The prediction unit and the partitions of a coding unit are arranged along the horizontal axis according to each depth. In other words, if the coding unit 1310 having a size of 64×64 and a depth of 0 is a prediction unit, the prediction unit may be split into partitions include in the encoding unit 1310, i.e. a partition 1310 having a size of 64×64, partitions 1312 having the size of 64×32, partitions 1314 having the size of 32×64, or partitions 1316 having the size of 32×32.

Similarly, a prediction unit of the coding unit 1320 having the size of 32×32 and the depth of 1 may be split into partitions included in the coding unit 1320, i.e. a partition 1320 having a size of 32×32, partitions 1322 having a size of 32×16, partitions 1324 having a size of 16×32, and partitions 1326 having a size of 16×16.

Similarly, a prediction unit of the coding unit 1330 having the size of 16×16 and the depth of 2 may be split into partitions included in the coding unit 1330, i.e. a partition having a size of 16×16 included in the coding unit 1330, partitions 1332 having a size of 16×8, partitions 1334 having a size of 8×16, and partitions 1336 having a size of 8×8.

Similarly, a prediction unit of the coding unit 1340 having the size of 8×8 and the depth of 3 may be split into partitions included in the coding unit 1340, i.e. a partition having a size of 8×8 included in the coding unit 1340, partitions 1342 having a size of 8×4, partitions 1344 having a size of 4×8, and partitions 1346 having a size of 4×4.

In order to determine a depth of the coding units constituting the LCU 1310, the coding unit determiner 820 of the video encoding apparatus 800 performs encoding for coding units corresponding to each depth included in the LCU 1310.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 1300. Alternatively, the minimum encoding error may be searched for by comparing the least encoding errors according to depths, by performing encoding for each depth as the depth deepens along the vertical axis of the hierarchical structure 1300. A depth and a partition having the minimum encoding error in the coding unit 1310 may be selected as the final depth and a partition mode of the coding unit 1310.

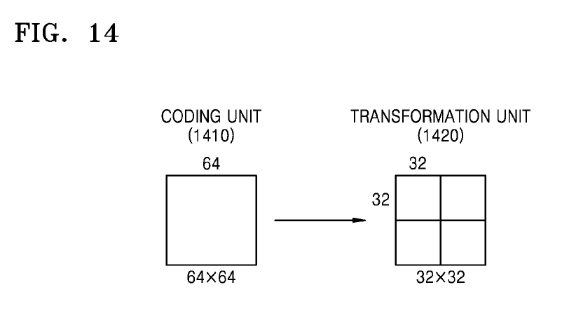

FIG. 14 is a diagram for describing a relationship between a coding unit and a transform unit, according to an embodiment.

The video encoding apparatus 800 or the video decoding apparatus 900 encodes or decodes an image according to coding units having sizes smaller than or equal to a LCU for each LCU. Sizes of transform units for transform during encoding may be selected based on data units that are not larger than a corresponding coding unit.

For example, in the video encoding apparatus 800 or the video decoding apparatus 900, if a size of the coding unit 1410 is 64×64, transform may be performed by using the transform units 1420 having a size of 32×32.

Also, data of the coding unit 1410 having the size of 64×64 may be encoded by performing the transform on each of the transform units having the size of 32×32, 16×16, 8×8, and 4×4, which are smaller than 64×64, and then a transform unit having the least coding error may be selected.

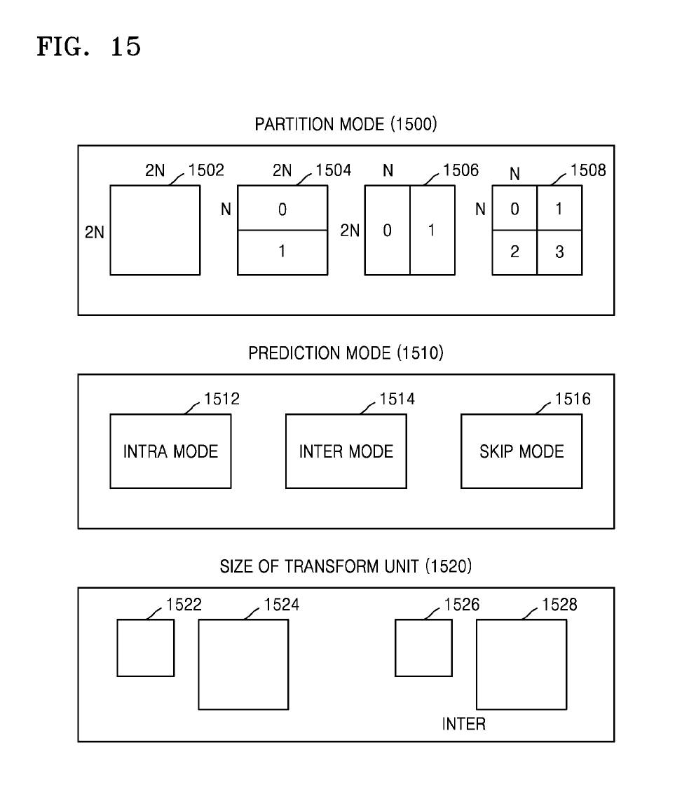

FIG. 15 is a diagram for describing encoding information, according to an embodiment.

The outputter 830 of the video encoding apparatus 800 may encode and transmit information 1500 about a partition mode, information 1510 about a prediction mode, and information 1520 about a size of a transform unit, for each coding unit corresponding to a final depth, as information about an encoding mode.

The information 1500 indicates information about a mode of a partition obtained by splitting a prediction unit of a current coding unit, wherein the partition is a data unit for prediction encoding the current coding unit. For example, a current coding unit CU_0 having a size of 2N×2N may be split into any one of a partition 1502 having a size of 2N×2N, a partition 1504 having a size of 2N×N, a partition 1506 having a size of N×2N, and a partition 1508 having a size of N×N. Here, the information 1500 about the partition mode is set to indicate one of the partition 1504 having a size of 2N×N, the partition 1506 having a size of N×2N, and the partition 1508 having a size of N×N.

The information 1510 indicates a prediction mode of each partition. For example, the information 1510 may indicate a mode of prediction encoding performed on a partition indicated by the information 1500, i.e., an intra mode 1512, an inter mode 1514, or a skip mode 1516.

The information 1520 indicates a transform unit to be based on when transform is performed on a current coding unit. For example, the transform unit may be a first intra transform unit 1522, a second intra transform unit 1524, a first inter transform unit 1526, or a second inter transform unit 1528.

The image data and encoding information extractor 1610 of the video decoding apparatus 900 may extract and use the information 1500, 1510, and 1520 for decoding, according to each deeper coding unit.

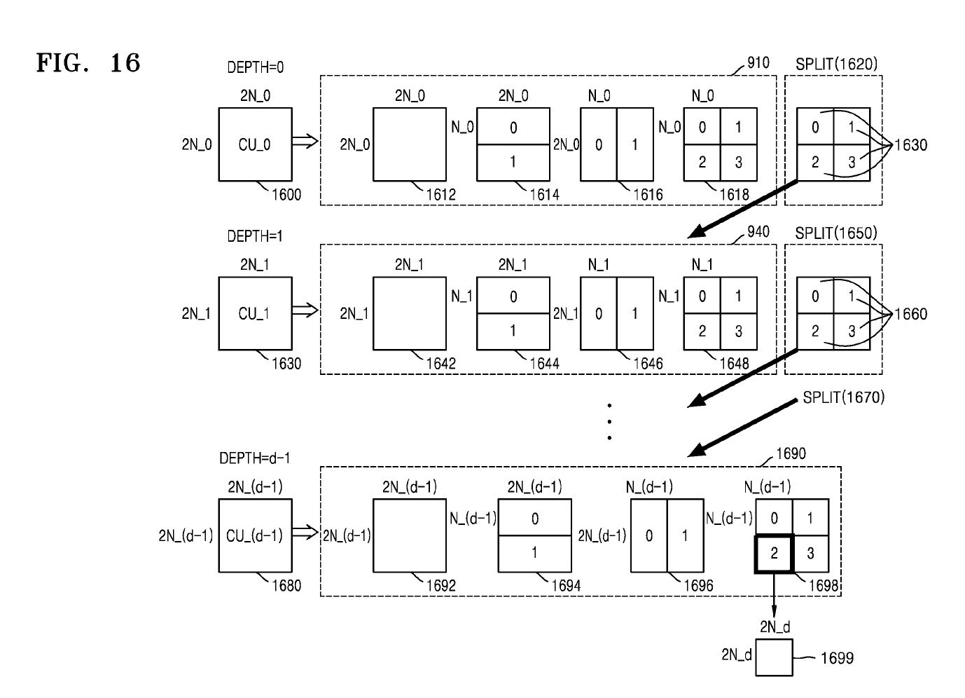

FIG. 16 is a diagram of deeper coding units according to depths, according to an embodiment.

Splitting information may be used to indicate a change of a depth. The spilt information indicates whether a coding unit of a current depth is split into coding units of a lower depth.

A prediction unit 1610 for prediction encoding a coding unit 1600 having a depth of 0 and a size of 2N_0×2N_0 may include partitions of a partition mode 1612 having a size of 2N_0×2N_0, a partition mode 1614 having a size of 2N_0 xN_0, a partition mode 1616 having a size of N_0×2N_0, and a partition mode 1618 having a size of N_0×N_0. FIG. 16 only illustrates the partition modes 1612 through 1618 which are obtained by symmetrically splitting the prediction unit 1610, but a partition mode is not limited thereto, and the partitions of the prediction unit 1610 may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition mode. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition modes 1612 through 1616, the prediction unit 1610 may not be split into a lower depth.

If the encoding error is the smallest in the partition mode 1618, a depth is changed from 0 to 1 to split the partition mode 1618 in operation 1620, and encoding is repeatedly performed on coding units 1630 having a depth of 2 and a size of N_0×N_0 to search for a minimum encoding error.

A prediction unit 1640 for prediction encoding the coding unit 1630 having a depth of 1 and a size of 2N_1×2N_1 (=N_0×N_0) may include partitions of a partition mode 1642 having a size of 2N_1×2N_1, a partition mode 1644 having a size of 2N_1×N_1, a partition mode 1646 having a size of N_1×2N_1, and a partition mode 1648 having a size of N_1×N_1.

If an encoding error is the smallest in the partition mode 1648, a depth is changed from 1 to 2 to split the partition mode 1648 in operation 1650, and encoding is repeatedly performed on coding units 1660, which have a depth of 2 and a size of N_2×N_2 to search for a minimum encoding error.

When a maximum depth is d, split operation according to each depth may be performed up to when a depth becomes d−1, and splitting information may be encoded as up to when a depth is one of 0 to d−2. In other words, when encoding is performed up to when the depth is d−1 after a coding unit corresponding to a depth of d−2 is split in operation 1670, a prediction unit 1690 for prediction encoding a coding unit 1680 having a depth of d−1 and a size of 2N_(d−1)×2N_(d−1) may include partitions of a partition mode 1692 having a size of 2N_(d−1)×2N_(d−1), a partition mode 1694 having a size of 2N_(d−1)×N_(d−1), a partition mode 1696 having a size of N_(d−1)×2N_(d−1), and a partition mode 1698 having a size of N_(d−1)×N_(d−1).

Prediction encoding may be repeatedly performed on one partition having a size of 2N_(d−1)×2N_(d−1), two partitions having a size of 2N_(d−1)×N_(d−1), two partitions having a size of N_(d−1)×2N_(d−1), four partitions having a size of N_(d−1)×N_(d−1) from among the partition modes 1692 through 1698 to search for a partition mode having a minimum encoding error.

Even when the partition mode 1698 has the minimum encoding error, since a maximum depth is d, a coding unit CU_(d−1) having a depth of d−1 is no longer split to a lower depth, and a depth for the coding units constituting a current LCU 1600 is determined to be d−1 and a partition mode of the current LCU 1600 may be determined to be N_(d−1)×N_(d−1). Also, since the maximum depth is d, splitting information for an SCU 1652 having a lowermost depth of d−1 is no longer set.

A data unit 1699 may be a “minimum unit” for the current LCU. A minimum unit according to an embodiment may be a square data unit obtained by splitting an SCU 1680 by 4. By performing the encoding repeatedly, the video encoding apparatus 800 may select a depth having the least encoding error by comparing encoding errors according to depths of the coding unit 1600 to determine a depth, and set a corresponding partition mode and a prediction mode as an encoding mode of the depth.

As such, the minimum encoding errors according to depths are compared in all of the depths of 1 through d, and a depth having the least encoding error may be determined as a depth. The depth, the partition mode of the prediction unit, and the prediction mode may be encoded and transmitted as information about an encoding mode. Also, since a coding unit is split from a depth of 0 to a depth, only splitting information of the depth is set to 0, and splitting information of depths excluding the depth is set to 1.

The image data and encoding information extractor 920 of the video decoding apparatus 900 may extract and use the information about the depth and the prediction unit of the coding unit 1600 to decode the partition 1612. The video decoding apparatus 900 may determine a depth, in which splitting information is 0, as a depth by using splitting information according to depths, and use information about an encoding mode of the corresponding depth for decoding.

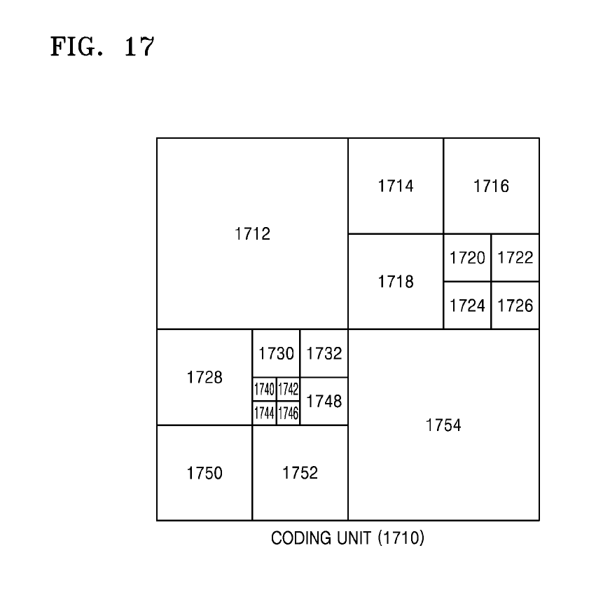

FIGS. 17 through 19 are diagrams for describing a relationship between coding units 1710, prediction units 1760, and transform units 1770, according to an embodiment.

The coding units 1710 are coding units having a tree structure, corresponding to depths determined by the video encoding apparatus 800, in a LCU. The prediction units 1760 are partitions of prediction units of each of the coding units 1710, and the transform units 1770 are transform units of each of the coding units 1710.

When a depth of a LCU is 0 in the coding units 1710, depths of coding units 1712 and 1754 are 1, depths of coding units 1714, 1716, 1718, 1728, 1750, and 1752 are 2, depths of coding units 1720, 1722, 1724, 1726, 1730, 1732, and 1748 are 3, and depths of coding units 1740, 1742, 1744, and 1746 are 4.

In the prediction units 1760, some encoding units 1714, 1716, 1722, 1732, 1748, 1750, 1752, and 1754 are obtained by splitting the coding units in the encoding units 1710. In other words, partition modes in the coding units 1714, 1722, 1750, and 1754 have a size of 2N×N, partition modes in the coding units 1716, 1748, and 1752 have a size of N×2N, and a partition mode of the coding unit 1732 has a size of N×N. Prediction units and partitions of the coding units 1710 are smaller than or equal to each coding unit.

Transform or inverse transform is performed on image data of the coding unit 1752 in the transform units 1770 in a data unit that is smaller than the coding unit 1752. Also, the coding units 1714, 1716, 1722, 1732, 1748, 1750, 1752, and 1754 are different from those in the prediction units 1760 in terms of sizes and shapes. In other words, the video encoding and decoding apparatuses 800 and 900 may perform intra prediction, motion estimation, motion compensation, transform, and inverse transform individually on a data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition mode, information about a prediction mode, and information about a size of a transform unit. Table 2 shows the encoding information that may be set by the video encoding and decoding apparatuses 800 and 900.

TABLE 2

| Splitting information 0 | | | | | Splitting |
|---|---|---|---|---|---|
| (Encoding on Coding Unit having Size of 2N × 2N and Current Depth of d) | | | | | information 1 |
| Prediction | Partition mode | | Size of Transform unit | | Repeatedly |
| Mode | | | | | Encode |
| Intra Inter | Symmetrical | Asymmetrical | Splitting | Splitting | Coding Units |
| Skip (Only | Partition | Partition | information 0 of | information 1 of | having Lower |
| 2N × 2N) | mode | mode | Transform unit | Transform unit | Depth of |
| | 2N × 2N | 2N × nU | 2N × 2N | N × N | d + 1 |
| | 2N × N | 2N × nD | | (Symmetrical Type) | |
| | N × 2N | nL × 2N | | N/2 × N/2 | |
| | N × N | nR × 2N | | (Asymmetrical Type) | |

The outputter 830 of the video encoding apparatus 800 may output the encoding information about the coding units having a tree structure, and the image data and encoding information extractor 920 of the video decoding apparatus 900 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a final depth, and thus information about a partition mode, prediction mode, and a size of a transform unit may be defined for the final depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition modes, and the skip mode is defined only in a partition mode having a size of 2N×2N.

The information about the partition mode may indicate symmetrical partition modes having sizes of 2N×2N, 2N×N, N×2N, and N×N, which are obtained by symmetrically splitting a height or a width of a prediction unit, and asymmetrical partition modes having sizes of 2N×nU, 2N×nD, nL×2N, and nR×2N, which are obtained by asymmetrically splitting the height or width of the prediction unit. The asymmetrical partition modes having the sizes of 2N×nU and 2N×nD may be respectively obtained by splitting the height of the prediction unit in 1:3 and 3:1, and the asymmetrical partition modes having the sizes of nL×2N and nR×2N may be respectively obtained by splitting the width of the prediction unit in 1:3 and 3:1

The size of the transform unit may be set to be two types in the intra mode and two types in the inter mode. In other words, if splitting information of the transform unit is 0, the size of the transform unit may be 2N×2N, which is the size of the current coding unit. If splitting information of the transform unit is 1, the transform units may be obtained by splitting the current coding unit. Also, if a partition mode of the current coding unit having the size of 2N×2N is a symmetrical partition mode, a size of a transform unit may be N×N, and if the partition mode of the current coding unit is an asymmetrical partition mode, the size of the transform unit may be N/2×N/2.

The encoding information about coding units having a tree structure may include at least one of a coding unit corresponding to a depth, a prediction unit, and a minimum unit. The coding unit corresponding to the depth may include at least one of a prediction unit and a minimum unit containing the same encoding information.

Accordingly, it is determined whether adjacent data units are included in the same coding unit corresponding to the depth by comparing encoding information of the adjacent data units. Also, a corresponding coding unit corresponding to a depth is determined by using encoding information of a data unit, and thus a distribution of depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

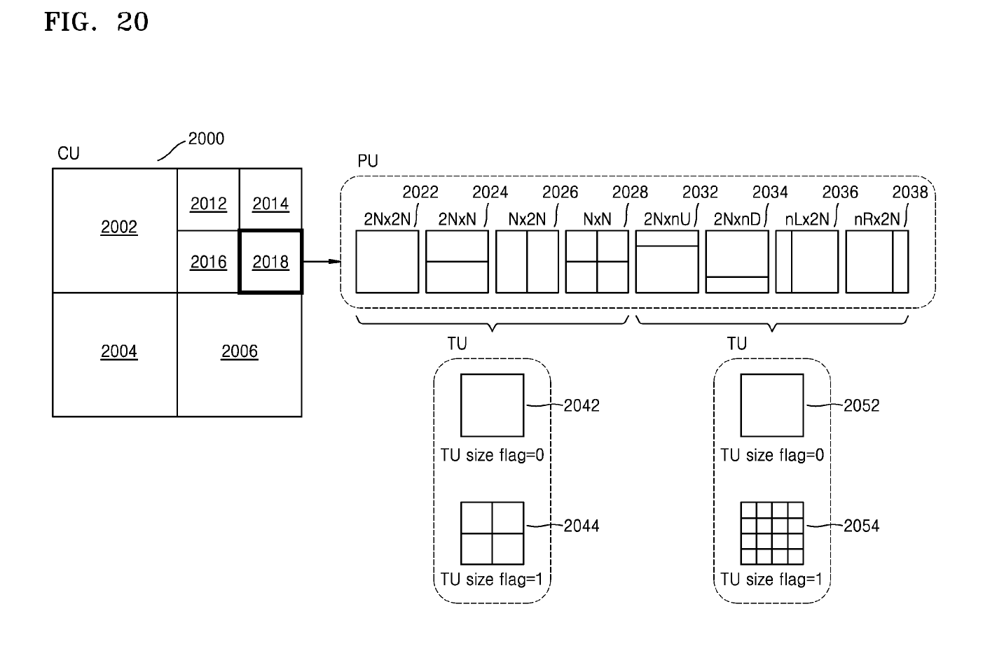

FIG. 20 is a diagram for describing a relationship between a coding unit, a prediction unit, and a transform unit, according to encoding mode information of Table 2.

A LCU 2000 includes coding units 2002, 2004, 2006, 2012, 2014, 2016, and 2018 of depths. Here, since the coding unit 2018 is a coding unit of a depth, splitting information may be set to 0. Information about a partition mode of the coding unit 2018 having a size of 2N×2N may be set to be one of a partition mode 2022 having a size of 2N×2N, a partition mode 2024 having a size of 2N×N, a partition mode 2026 having a size of N×2N, a partition mode 2028 having a size of N×N, a partition mode 2032 having a size of 2N×nU, a partition mode 2034 having a size of 2N×nD, a partition mode 2036 having a size of nL×2N, and a partition mode 2038 having a size of nR×2N.

Splitting information (TU size flag) of a transform unit is a type of a transform index. The size of the transform unit corresponding to the transform index may be changed according to a prediction unit type or partition mode of the coding unit.

For example, when the partition mode is set to be symmetrical, i.e. the partition mode 2022, 2024, 2026, or 2028, a transform unit 2042 having a size of 2N×2N is set if a TU size flag of a transform unit is 0, and a transform unit 2044 having a size of N×N is set if a TU size flag is 1.

When the partition mode is set to be asymmetrical, i.e., the partition mode 2032, 2034, 2036, or 2038, a transform unit 2052 having a size of 2N×2N is set if a TU size flag is 0, and a transform unit 2054 having a size of N/2×N/2 is set if a TU size flag is 1.

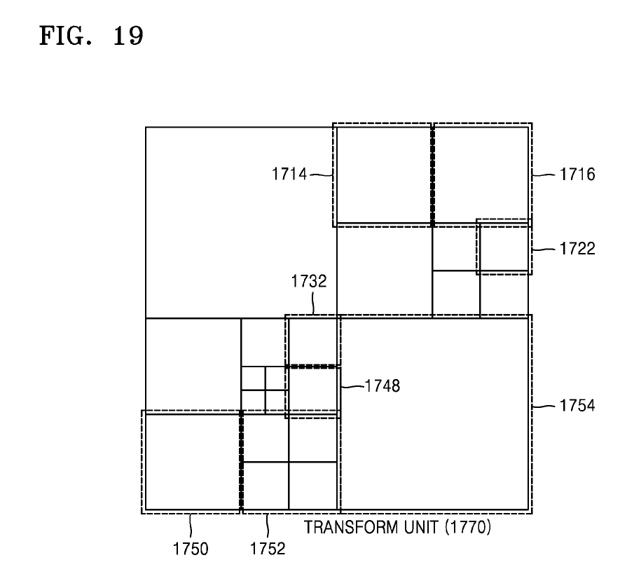

Referring to FIG. 19, the TU size flag is a flag having a value or 0 or 1, but the TU size flag is not limited to 1 bit, and a transform unit may be hierarchically split having a tree structure while the TU size flag increases to 0, 1, 2, 3, . . . . Splitting information (TU size flag) of a transform unit may be an example of a transform index.

In this case, the size of a transform unit that has been actually used may be expressed by using a TU size flag of a transform unit, according to an embodiment, together with a maximum size and minimum size of the transform unit. The video encoding apparatus 800 is capable of encoding maximum transform unit size information, minimum transform unit size information, and a maximum TU size flag. The result of encoding the maximum transform unit size information, the minimum transform unit size information, and the maximum TU size flag may be inserted into an SPS. The video decoding apparatus 900 may decode video by using the maximum transform unit size information, the minimum transform unit size information, and the maximum TU size flag.

For example, (a) if the size of a current coding unit is 64×64 and a maximum transform unit size is 32×32, (a−1) then the size of a transform unit may be 32×32 when a TU size flag is 0, (a−2) may be 16×16 when the TU size flag is 1, and (a−3) may be 8×8 when the TU size flag is 2.

As another example, (b) if the size of the current coding unit is 32×32 and a minimum transform unit size is 32×32, (b−1) then the size of the transform unit may be 32×32 when the TU size flag is 0. Here, the TU size flag cannot be set to a value other than 0, since the size of the transform unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is “MaxTransformSizeIndex”, a minimum transform unit size is “MinTransformSize”, and a transform unit size is “RootTuSize” when the TU size flag is 0, then a current minimum transform unit size “CurrMinTuSize” that can be determined in a current coding unit, may be defined by Equation (1):

CurrMinTuSize=max(MinTransformSize,RootTuSize/(2̂MaxTransformSizeIndex)) (1)

Compared to the current minimum transform unit size “CurrMinTuSize” that can be determined in the current coding unit, a transform unit size “RootTuSize” when the TU size flag is 0 may denote a maximum transform unit size that can be selected in the system. In Equation (1), “RootTuSize/(2̂MaxTransformSizeIndex)” denotes a transform unit size when the transform unit size “RootTuSize”, when the TU size flag is 0, is split a number of times corresponding to the maximum TU size flag, and “MinTransformSize” denotes a minimum transform size. Thus, a smaller value from among “RootTuSize/(2̂MaxTransformSizeIndex)” and “MinTransformSize” may be the current minimum transform unit size “CurrMinTuSize” that can be determined in the current coding unit.

According to an embodiment, the maximum transform unit size RootTuSize may vary according to the type of a prediction mode.

For example, if a current prediction mode is an inter mode, then “RootTuSize” may be determined by using Equation (2) below. In Equation (2), “MaxTransformSize” denotes a maximum transform unit size, and “PUSize” denotes a current prediction unit size.

RootTuSize=min(MaxTransformSize,PUSize) (2)

That is, if the current prediction mode is the inter mode, the transform unit size “RootTuSize”, when the TU size flag is 0, may be a smaller value from among the maximum transform unit size and the current prediction unit size.

If a prediction mode of a current partition unit is an intra mode, “RootTuSize” may be determined by using Equation (3) below. In Equation (3), “PartitionSize” denotes the size of the current partition unit.

RootTuSize=min(MaxTransformSize,PartitionSize) (3)

That is, if the current prediction mode is the intra mode, the transform unit size “RootTuSize” when the TU size flag is 0 may be a smaller value from among the maximum transform unit size and the size of the current partition unit.

However, the current maximum transform unit size “RootTuSize” that varies according to the type of a prediction mode in a partition unit is just an example and the embodiments are not limited thereto.

According to the video encoding method based on coding units having a tree structure as described with reference to FIGS. 8 through 20, image data of the spatial domain is encoded for each coding unit of a tree structure. According to the video decoding method based on coding units having a tree structure, decoding is performed for each LCU to reconstruct image data of the spatial domain. Thus, a picture and a video that is a picture sequence may be reconstructed. The reconstructed video may be reproduced by a reproducing apparatus, stored in a storage medium, or transmitted through a network.

The embodiments may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of explanation, the video encoding method and/or the video encoding method described above with reference to FIGS. 1A through 20, will be referred to as a “video encoding method according to the various embodiments”. In addition, the video decoding method and/or the video decoding method described above with reference to FIGS. 1A through 20, will be referred to as a “video decoding method according to the various embodiments”.

A video encoding apparatus including the video encoding apparatus, the video encoding apparatus 800, or the video encoder 1100, which is described above with reference to FIGS. 1A through 20, will be referred to as a “video encoding apparatus according to the various embodiments”. In addition, a video decoding apparatus including the inter layer video decoding apparatus, the video decoding apparatus 900, or the video decoder 1200, which is described above with reference to FIGS. 1A through 20, will be referred to as a “video decoding apparatus according to the various embodiments”.

A computer-readable recording medium storing a program, e.g., a disc 26000, according to various embodiments will now be described in detail.

FIG. 21 is a diagram of a physical structure of the disc 26000 in which a program is stored, according to an embodiment. The disc 26000, which is a storage medium, may be a hard drive, a compact disc-read only memory (CD-ROM) disc, a Blu-ray disc, or a digital versatile disc (DVD). The disc 26000 includes a plurality of concentric tracks

Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

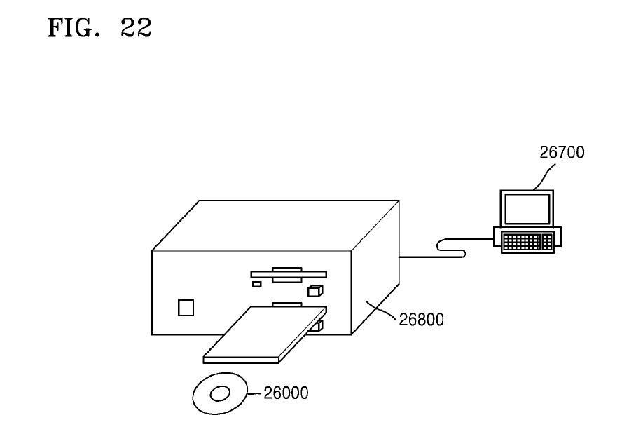

A computer system embodied using a storage medium that stores a program for executing the video encoding method and the video decoding method as described above will now be described with reference to FIG. 22.

FIG. 22 is a diagram of a disc drive 26800 for recording and reading a program by using the disc 26000. A computer system 26700 may store a program that executes at least one of a video encoding method and a video decoding method according to an embodiment, in the disc 26000 via the disc drive 26800. To run the program stored in the disc 26000 in the computer system 26700, the program may be read from the disc 26000 and be transmitted to the computer system 26700 by using the disc drive 26800.

The program that executes at least one of a video encoding method and a video decoding method according to an embodiment may be stored not only in the disc 26000 illustrated in FIG. 21 or 22 but also in a memory card, a ROM cassette, or a solid state drive (SSD).

A system to which the video encoding method and a video decoding method described above are applied will be described below.

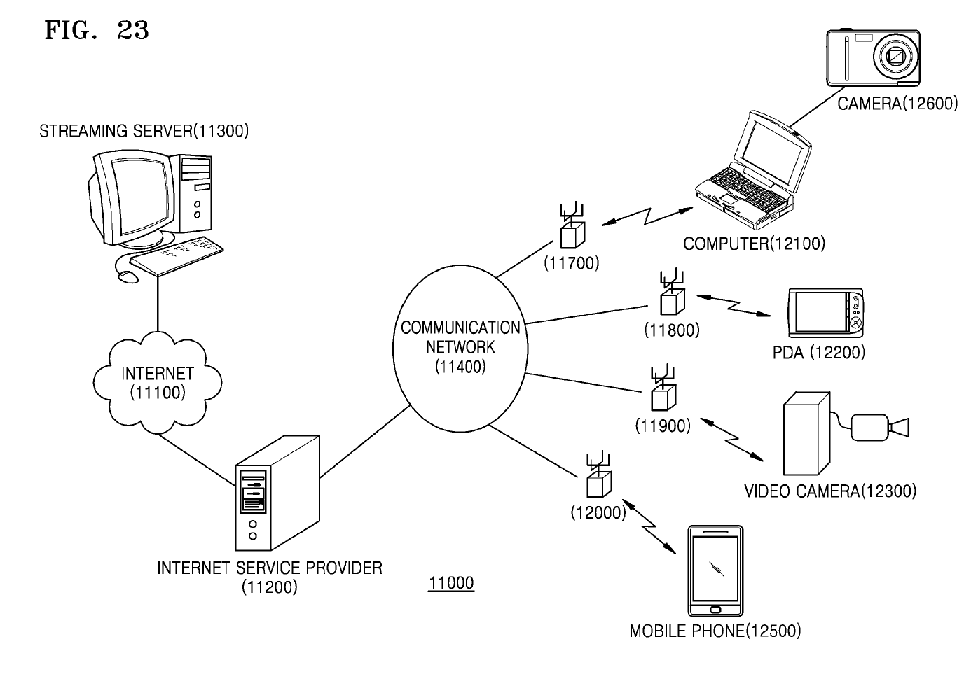

FIG. 23 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

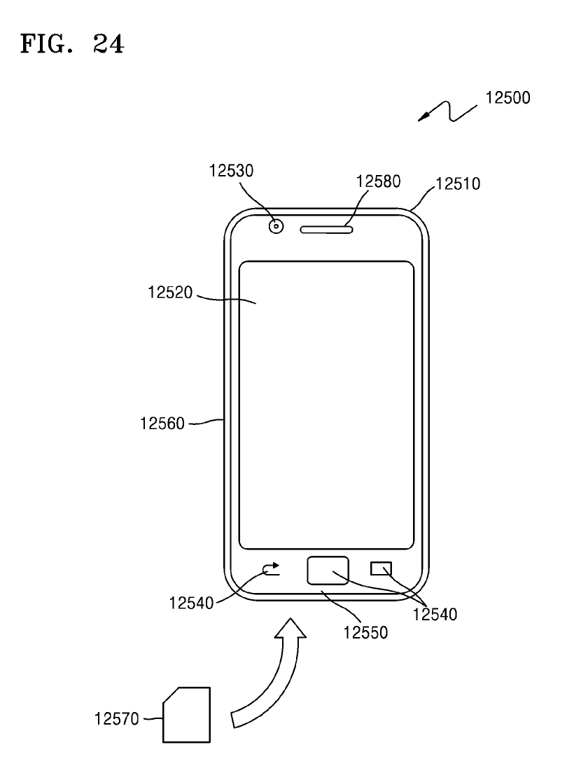

However, the content supply system 11000 is not limited to as illustrated in FIG. 24, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to an embodiment.

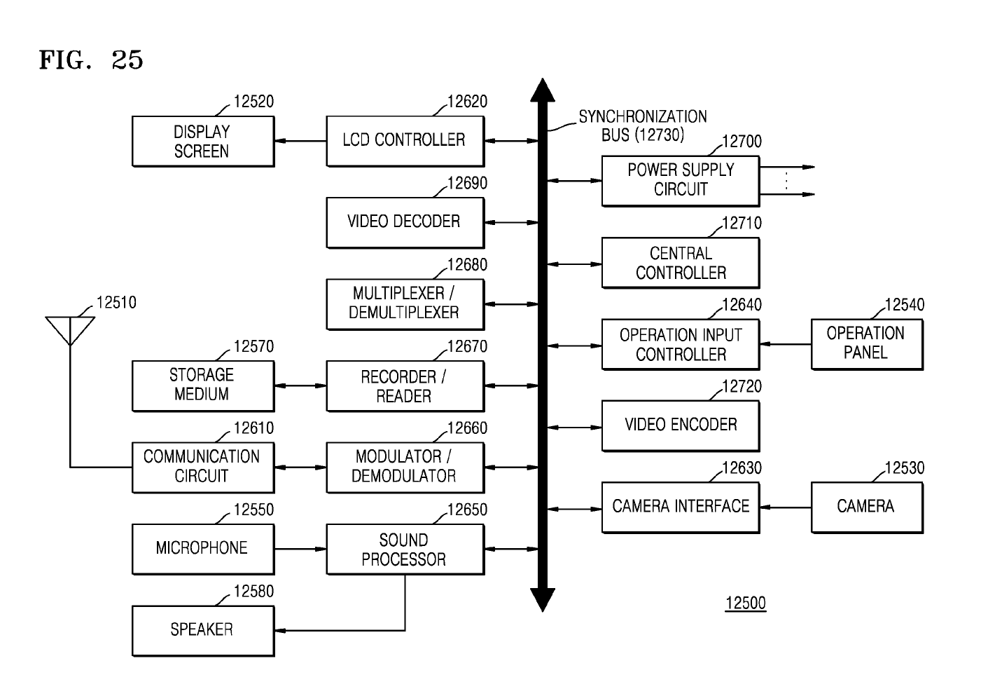

The mobile phone 12500 included in the content supply system 11000 according to an embodiment will now be described in greater detail with referring to FIGS. 24 and 25.

FIG. 24 illustrates an external structure of the mobile phone 12500 to which a video encoding method and a video decoding method are applied, according to an embodiment. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12510 (includes an operation panel 12540 including a control button and a touch panel. If the display screen 12520 is a touch screen, the operation panel 12540 further includes a touch sensing panel of the display screen 12520. The mobile phone 12510 includes a speaker 12580 for outputting voice and sound or another type of sound outputter, and a microphone 12550 for inputting voice and sound or another type sound inputter. The mobile phone 12510 further includes the camera 12530, such as a charge-coupled device (CCD) camera, to capture video and still images. The mobile phone 12510 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 25 illustrates an internal structure of the mobile phone 12500, according to an embodiment. To systemically control parts of the mobile phone 12500 including the display screen 12520 and the operation panel 12540, a power supply circuit 12700, an operation input controller 12640, a video encoder 12720, a camera interface 12630, an LCD controller 12620, a video decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a “power off” state to a “power on” state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the video encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transform signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12610 via the operation input controller 12640. Under control of the central controller 12610, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the video encoder 12720 via the camera interface 12630. The image data captured by the camera 12530 may be directly displayed on the display screen 12520 via the camera interface 12630 and the LCD controller 12620.

A structure of the video encoder 12720 may correspond to that of the above-described video encoding method according to the embodiment. The video encoder 12720 may transform the image data received from the camera 12530 into compressed and encoded image data based on the above-described video encoding method according to the an embodiment, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the video encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 demodulates a frequency band of the digital signal. The frequency-band demodulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the video decoder 12690 may correspond to that of the above-described video decoding method according to the embodiment. The video decoder 12690 may decode the encoded video data to obtain reconstructed video data and provide the reconstructed video data to the display screen 12520 via the LCD controller 12620, by using the above-described video decoding method according to the an embodiment.

Thus, the data of the video file accessed at the Internet website may be displayed on the display screen 1252. At the same time, the sound processor 1265 may transform audio data into an analog sound signal, and provide the analog sound signal to the speaker 1258. Thus, audio data contained in the video file accessed at the Internet website may also be reproduced via the speaker 1258.

The mobile phone 1250 or another type of communication terminal may be a transceiving terminal including both a video encoding apparatus and a video decoding apparatus according to an embodiment, may be a transceiving terminal including only the video encoding apparatus, or may be a transceiving terminal including only the video decoding apparatus.

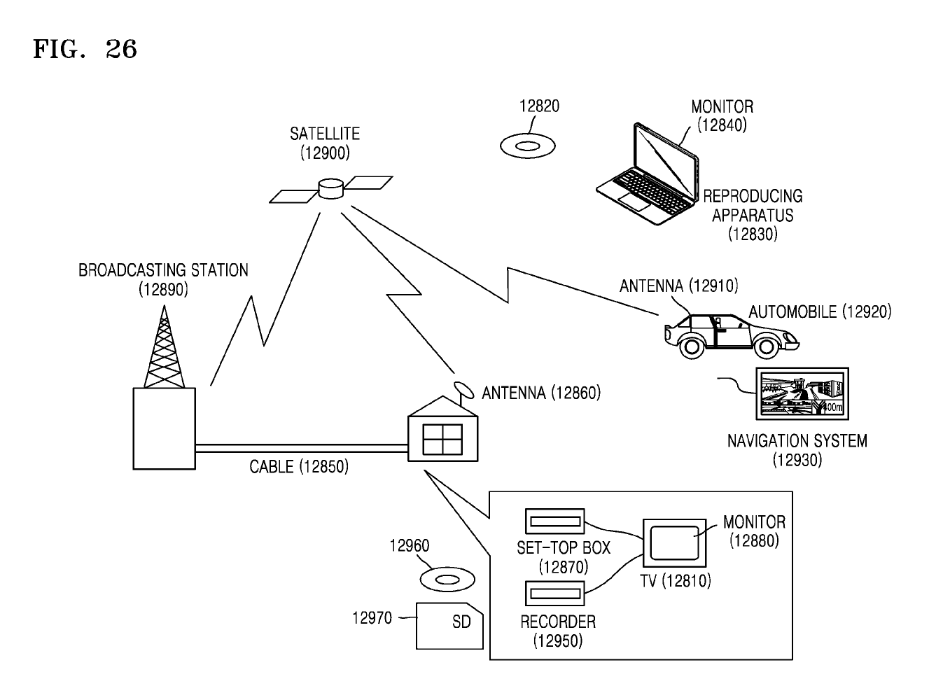

A communication system according to the embodiment is not limited to the communication system described above with reference to FIG. 24. For example, FIG. 26 illustrates a digital broadcasting system employing a communication system, according to an embodiment. The digital broadcasting system of FIG. 26 may receive a digital broadcast transmitted via a satellite or a terrestrial network by using a video encoding apparatus and a video decoding apparatus according to an embodiment.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to an embodiment is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to an embodiment may be installed. Data output from the set-top box 12870 may also be reproduced on a TV monitor 12880.

As another example, a video decoding apparatus according to an embodiment may be installed in the TV receiver 12810 instead of the set-top box 12870.

An automobile 12920 that has an appropriate antenna 12910 may receive a signal transmitted from the satellite 12800 or the wireless base station 11700. A decoded video may be reproduced on a display screen of an automobile navigation system 12930 installed in the automobile 12920.

A video signal may be encoded by a video encoding apparatus according to an embodiment and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to an embodiment, a video signal recorded on the DVD disc 12960, the SD card 12970, or another storage medium may be reproduced on the TV monitor 12880.

The automobile navigation system 12930 may not include the camera 12530, and the camera interface 12630 and the video encoder 12720 of FIG. 26. For example, the computer 12100 and the TV receiver 12810 may not include the camera 12530, the camera interface 12630, and the video encoder 12720.

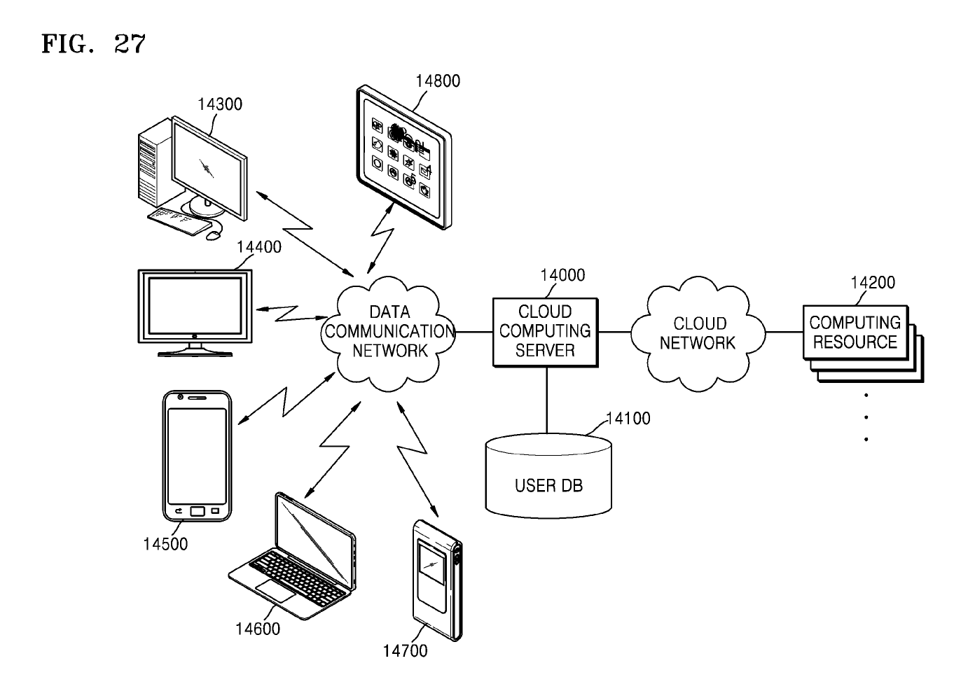

FIG. 27 is a diagram illustrating a network structure of a cloud computing system using a video encoding apparatus and a video decoding apparatus, according to an embodiment.

The cloud computing system may include a cloud computing server 14100, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14100 via a data communication network including the Internet and a mobile telecommunication network. User terminals may be provided cloud computing services, and particularly video reproduction services, from the cloud computing server 14100. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14100 may combine the plurality of computing resources 14200 distributed in a cloud network and provide user terminals with a result of combining. The plurality of computing resources 14200 may include various data services, and may include data uploaded from user terminals. As described above, the cloud computing server 14100 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14100 searches for and reproduces this video service, based on the user DB 14100. When the smart phone 14500 receives a video data stream from the cloud computing server 14100, a process of reproducing video by decoding the video data stream is similar to an operation of the mobile phone 12500 described above with reference to FIG. 24.

The cloud computing server 14100 may refer to a reproduction history of a desired video service, stored in the user DB 14100. For example, the cloud computing server 14100 receives a request to reproduce a video stored in the user DB 14100, from a user terminal. If this video was being reproduced, then a method of streaming this video, performed by the cloud computing server 14100, may vary according to the request from the user terminal, i.e., according to whether the video will be reproduced, starting from a start thereof or a pausing point thereof. For example, if the user terminal requests to reproduce the video, starting from the start thereof, the cloud computing server 14100 transmits streaming data of the video starting from a first frame thereof to the user terminal. If the user terminal requests to reproduce the video, starting from the pausing point thereof, the cloud computing server 14100 transmits streaming data of the video starting from a frame corresponding to the pausing point, to the user terminal. In this case, the user terminal may include a video decoding apparatus as described above with reference to FIGS. 1A through 20. As another example, the user terminal may include a video encoding apparatus as described above with reference to FIGS. 1A through 20. Alternatively, the user terminal may include both the video decoding apparatus and the video encoding apparatus as described above with reference to FIGS. 1A through 20.

Various applications of a video encoding method, a video decoding method, a video encoding apparatus, and a video decoding apparatus according to the an embodiment described above with reference to FIGS. 1A through 20 have been described above with reference to FIGS. 21 to 27. However, methods of storing the video encoding method and the video decoding method in a storage medium or methods of implementing the video encoding apparatus and the video decoding apparatus in a device, according to various embodiments, described above with reference to FIGS. 1A through 20 are not limited to the embodiments described above with reference to FIGS. 21 to 27.

It should be understood that the exemplary embodiments described therein should be considered in a descriptive sense only and not for purposes of limitation. Descriptions of features or aspects within each embodiment should typically be considered as available for other similar features or aspects in other embodiments.

While an embodiment of the present invention have been described with reference to the figures, it will be understood by those of ordinary skill in the art that various changes in form and details may be made therein without departing from the spirit and scope of the present invention as defined by the following claims.

1. A video decoding method, which is performed by a multilayer video decoding apparatus, comprising:
acquiring a bitstream of an encoded image;
acquiring from the bitstream a video parameter set network abstraction layer (VPS NAL) unit including parameter information that is commonly used to decode base layer coded data and enhancement layer coded data;
acquiring video format information that is commonly used to decode the base layer coded data and the enhancement layer coded data, by using the VPS NAL unit; and
decoding the enhancement layer coded data using the video format information,
wherein the video format information comprises at least one of spatial resolution information, luma and chroma specification information, color specification information, and viewpoint specification information.

2. The video decoding method of claim 1, wherein the acquiring of the video format information comprises:
acquiring from the VPS NAL unit an extension information identifier indicating whether extension information of the VPS NAL unit is supplied; and
if a value of the extension information identifier is 1, acquiring the extension information of the VPS NAL unit from the bitstream, and the video format information from the extension information.

3. The video decoding method of claim 2, wherein the acquiring of the video format information from the extension information comprises:
acquiring from the extension information a video format information identifier indicating whether the video format information is supplied; and
if a value of the video format information identifier is 1, acquiring the video format information from the bitstream.

4. The video decoding method of claim 1, wherein the acquiring of the video format information comprises acquiring information indicating whether a color component of a chroma format of at least one layer in the at least one layer indicated by the VPS NAL unit is encoded.

5. The video decoding method of claim 1, wherein the acquiring of the video format information comprises acquiring information indicating a coded picture width of a luma sample of at least one layer in the at least one layer indicated by the VPS NAL unit.

6. The video decoding method of claim 1, wherein the acquiring of the video format information comprises acquiring information indicating a bit depth of luma array samples of at least one layer in the at least one layer indicated by the VPS NAL unit.

7. The video decoding method of claim 1, wherein the acquiring of the video format information comprises:
acquiring a color specification identifier indicating whether chromaticity information, transfer characteristics information, and RGB-to-YCC transform matrix information are supplied to the VPS NAL unit; and
if a value of the color specification identifier is 1, acquiring at least one of chromaticity information, transfer characteristics information, and RGB-to-YCC transform matrix information from the VPS NAL unit.

8. The video decoding method of claim 1, wherein the acquiring of the video format information comprises acquiring a neutral chroma identifier indicating whether all values of coded chroma samples generated through decoding are the same, and
the decoding of the enhancement layer coded data comprises, if a value of the neutral chroma identifier is 1, generating values of chroma samples decoding by using the VPS NAL unit to be identical to each other.

9. The video decoding method of claim 8, wherein the generating of the chroma samples comprises determining values of the chroma samples with values of the chroma samples determined by using a bit depth of the chroma samples with respect to each layer acquired from the VPS NAL unit.

10. The video decoding method of claim 1, wherein the acquiring of the video format information comprises:
acquiring a viewpoint specification information indicating whether viewpoint specification information of a camera capturing an image is supplied to the VPS NAL unit; and
if a value of the viewpoint specification information identifier is 1, acquiring a transform parameter to transform a depth value to a disparity value from the VPS NAL unit.

11. The video decoding method of claim 1, wherein the VPS NAL unit is located prior to a picture parameter set (PPS) NAL unit including parameter information that is commonly used to decode coded data of at least one picture of the image and a sequence parameter set (SPS) NAL unit including parameter information that is commonly used to decode coded data of pictures to be decoded by referring to a plurality of PPS NAL units, in a bitstream of the encoded image.

12. A method of encoding an image, which is performed by a multilayer video encoding apparatus, comprising:
generating base layer coded data and enhancement layer coded data by encoding an input image;
generating video format information that is commonly used to decode the base layer coded data and the enhancement layer coded data;
generating a video parameter set network abstraction layer (VPS NAL) unit including parameter information that is commonly used to decode the base layer coded data and the enhancement layer coded data; and
generating a bitstream including the VPS NAL unit,
wherein the video format information comprises at least one of spatial resolution information, luma and chroma specification information, color specification information, and viewpoint specification information.

13. A non-transitory computer readable storage medium having stored thereon a program, which when executed by a computer, performs the method defined in claim 1.

14. A video decoding method in a multilayer video encoding apparatus, comprising:
a bitstream acquirer acquiring a bitstream of an encoded image; and
an image decoder acquiring from the bitstream a video parameter set network abstraction layer (VPS NAL) unit including parameter information that is commonly used to decode base layer coded data and enhancement layer coded data, acquiring video format information that is commonly used to decode the base layer coded data and the enhancement layer coded data, by using the VPS NAL unit, and decoding the enhancement layer coded data using the video format information,
wherein the video format information comprises at least one of spatial resolution information, luma and chroma specification information, color specification information, and viewpoint specification information.

15. A video encoding apparatus in a multilayer video encoding apparatus, comprising:
an encoder generating base layer coded data and enhancement layer coded data by encoding an input image, generating video format information that is commonly used to decode the base layer coded data and the enhancement layer coded data, and generating a video parameter set network abstraction layer (VPS NAL) unit including parameter information that is commonly used to decode the base layer coded data and the enhancement layer coded data; and
a bitstream generator generating a bitstream including the VPS NAL unit,
wherein the video format information comprises at least one of spatial resolution information, luma and chroma specification information, color specification information, and viewpoint specification information.
